(19) United States
(12) Patent Application Publication
(10) Pub. No.: US 2007/0245369 A1
(43) Pub. Date: Oct. 18, 2007

(54) Lockbox management system and method

(75) Inventors: James Alfred Thompson, Houston, TX (US); David Strawn, Marietta, GA (US); Michael Rubinstein, Alpharetta, GA (US); Stuckey McIntosh, Atlanta, GA (US)

Correspondence Address: OSHA LIANG L.L.P., 1221 MCKINNEY STREET, SUITE 2800, HOUSTON, TX, 77010, US

(73) Assignee: REMOTE SECURITY SYSTEMS, LLC, Houston, TX (US)

(21) Appl. No.: 11/803,413

(22) Filed: May 14, 2007

Related U.S. Application Data
(63) Continuation-in-part of application No. 10/656,687, filed on Sep. 5, 2003.
(60) Provisional application No. 60/800,577, filed on May 15, 2006.

(51) Int. Cl. H04N 7/16

(52) U.S. Cl. 725/30

(57) ABSTRACT

A lockbox that includes an access device reader configured to obtain a key code from an access device, an access control system, operatively connected to an access administration system, configured to grant access to the lockbox when the key code is verified, and a bidirectional programmable multitap (BPMT) comprising a microprocessor and a tap, wherein the BPMT is controlled by the access control system and wherein the BPMT is configured to send status information about the tap to the access control system.

### CROSS-REFERENCE TO RELATED APPLICATIONS

This application claims priority to U.S. Provisional Application Ser. No. 60/800,577 entitled “Lockbox Management System and Method,” filed on May 15, 2006, in the names of James Alfred Thompson, David Strawn, Michael Rubinstein, and Stuckey Mcintosh and is hereby incorporated by reference. Additionally, this application is a Continuation-in-Part of application Ser. No. 10/656,687, filed Sep. 5, 2003, entitled “Cable Network Access Control Solution,” and assigned to the assignee of the present invention, and is hereby incorporated by reference.

### BACKGROUND

A cable network infrastructure includes a Headend, which is typically connected by fiber optic cable, microwave, or coaxial cable to a Hub Site. Coaxial cable is cable with a solid central conductor surrounded by an insulator, which is in turn surrounded by a cylindrical shield. It is used to carry high frequency signals such as video, voice, data, or radio. The shield is usually connected to an electrical ground to reduce electrical interference. The Headend is the facility that houses equipment for the reception of satellite signals, off-air broadcast signals, digital and analog transmission equipment, as well as other signal processing/control computers and equipment. Hub sites are facilities where fiber optic or microwave transmission/reception equipment is located to receive signals from the Headend and convert and/or amplify signals so they can be sent through additional fiber optic or coaxial cables to residential or commercial areas.

The signal from the Headend is sent to the Hub site and is subsequently transmitted via fiber optic transmission systems to one or more fiber receive/transmit Hubs, then in turn an optical signal is converted to an electrical signal for transmission over coaxial cable, often through several signal amplifiers, to one or more cable distribution boxes (CDB). The CDB is often a reinforced box structure with a traditional mechanical locking device. The CDB includes devices known as taps, which connect larger coaxial cable to smaller coaxial cables known as drops. The drops carry the electrical signal to a specific location, e.g., apartment, condo, townhouse, house, office, etc.

In the case of the multi-dwelling units, (i.e., apartment complexes, condo's, townhouses, offices, etc.), the CDB provides security against theft of cable signals by restricting access to the taps and drop connections leading to each multi-dwelling unit. To access the CDB, a service technician must use the appropriate key to unlock the CDB. Access to the CDB is not monitored beyond restricting the distribution of the keys to access the CDB. Because not all cable signals are encrypted or scrambled (in part due to FCC regulation and in part for marketing reasons), it is possible to steal cable service if one can gain unauthorized access to the CDB and make the simple mechanical drop connection. Because the locking devices on a CDB are normally ordinary key mechanical locks (e.g., padlocks, cylinder locks, etc.), and access to the CDB is not monitored, theft of cable services using duplicated keys or other unauthorized access can occur.

### SUMMARY

In general, in one aspect, the invention relates to a lockbox that includes an access device reader configured to obtain a key code from an access device, an access control system, operatively connected to an access administration system, configured to grant access to the lockbox when the key code is verified, and a bidirectional programmable multitap (BPMT) comprising a microprocessor and a tap, wherein the BPMT is controlled by the access control system and wherein the BPMT is configured to send status information about the tap to the access control system.

In general, in one aspect, the invention relates to a system, that includes a lockbox, wherein the lockbox includes an access device reader configured to obtain a key code from an access device, an access control system configured to grant access to the lockbox when the key code is verified, and a bidirectional programmable multitap (BPMT) comprising a microprocessor and a tap, wherein the BPMT is controlled by the access control system and wherein the BPMT is configured to send status information about the tap to the access control system, and the access administration system, operatively connected to the access control system, configured to verify the key code.

In general, in one aspect, the invention relates to a computer readable medium comprising computer readable program code embodied therein for causing the access control system to obtain status information from a bidirectional programmable multitap (BPMT), wherein the BPMT comprises a tap and wherein the status information comprises a status of the tap, and send the status information to an access administration system operatively connected to the access control system.

Other aspects of the invention will be apparent from the following description and the appended claims.

### BRIEF DESCRIPTION OF DRAWINGS

FIGS. 1-4 show schematic diagrams in accordance with one or more embodiments of the invention.

FIGS. 5-9 show flowcharts in accordance with one or more embodiments of the invention.

FIGS. 10-17D show example user interfaces in accordance with one or more embodiments of the invention.

FIG. 18 shows a computer system in accordance with one or more embodiments of the invention.

### DETAILED DESCRIPTION

Specific embodiments of the invention will now be described in detail with reference to the accompanying figures. Like elements in the various figures are denoted by like reference numerals for consistency. Further, the use of “ST” in the drawings is equivalent to the use of “Step” in the detailed description below.

In the following detailed description of embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid unnecessarily complicating the description.

In general, embodiments of the invention relate to a lockbox and a system for securing the lockbox. In one embodiment of the invention, the lockbox corresponds to a cable distribution box.

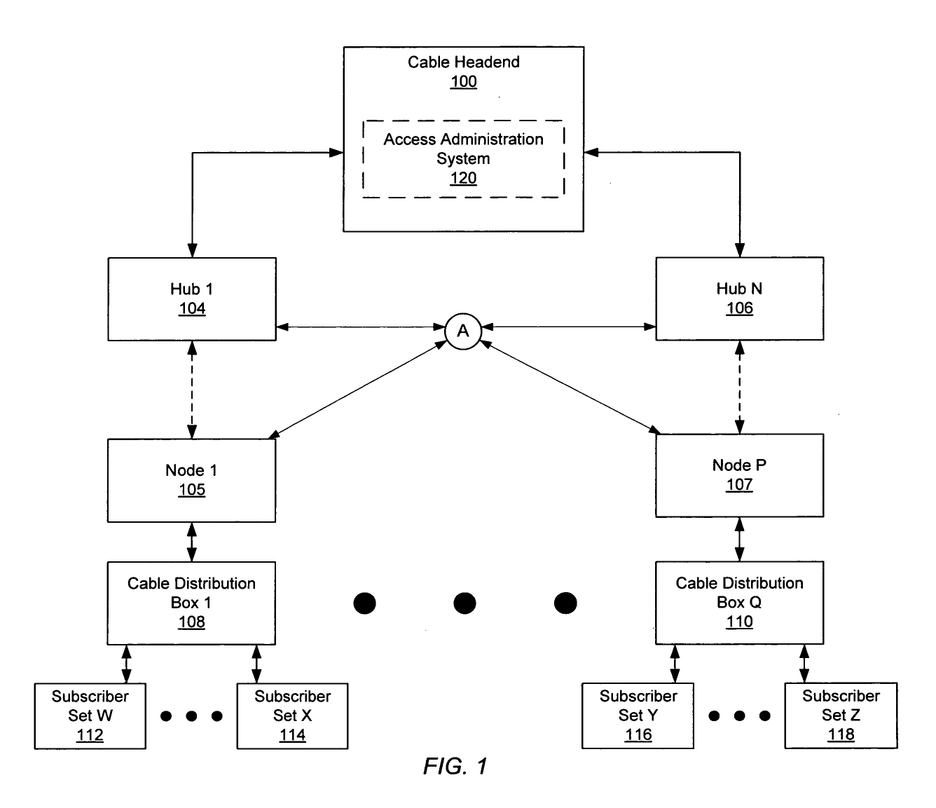

FIGS. 1-4 show schematic diagrams in accordance with one or more embodiments of the invention. FIG. 1 shows a schematic diagram of a cable network infrastructure in accordance with one or more embodiments of the invention. The cable network infrastructure includes a Headend (100), which is typically connected by a combination of fiber optic cable, microwave, and coaxial cable to one or more Hubs (104, 106). In one embodiment of the invention, the Headend (100) is the facility that houses equipment for the reception of satellite signals, off-air broadcast signals, digital and analog transmission equipment, as well as other signal processing/control computers and equipment. In one embodiment of the invention, the Hubs (104, 106) are facilities where fiber optic or microwave transmission/reception equipment is located to receive signals from the Headend (100) and convert and/or amplify signals so they can be sent through additional fiber optic or coaxial cables to residential or commercial areas.

In one embodiment of the invention, the signal from the Headend (100) is sent via a fiber optic transmission system to a Hub (104, 106), then in turn an optical signal is converted at a node (105, 107) to an electrical signal for transmission over coaxial cable, often through several signal amplifiers, to a CDB (108, 110). As shown in FIG. 1, multiple connection possibilities may be used to transmit the signal from the hubs (104, 106) to the nodes (105, 107). For example, multiple hubs may connect to the same node or set of nodes or a single hub may be connected to a single node or set of nodes. Further, the hub (104, 106) may be located at the cable headend (100). In one embodiment of the invention, the CDB (108, 110) controls the signal to one or more subscriber sets (112, 114, 116, 118). In one embodiment of the invention, a subscriber set (112, 114, 116, 118) may be any type of data receiving unit, such as a television, computer, or any other electronic device. The CDB (108, 110) may service one or more single dwelling units, one or more commercial real estate locations, one or more multi-dwelling units, or any combination thereof.

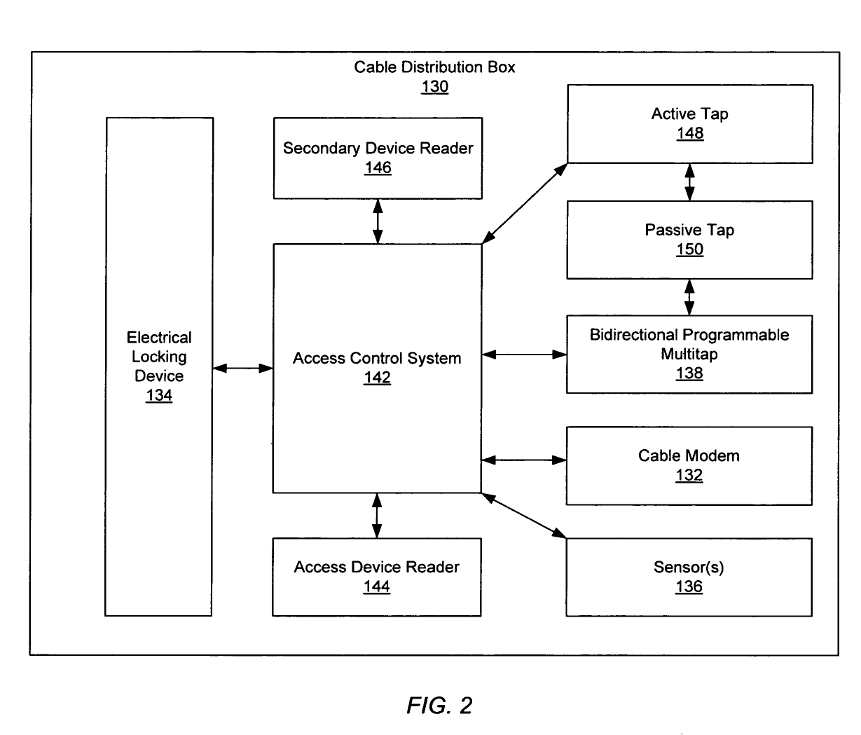

FIG. 2 shows a schematic diagram of a CDB (130) in accordance with one or more embodiments of the invention. Each existing CDB (130) may be retrofitted, or alternatively, each new CDB (130) may be designed such that each modified CDB (130) (i.e., new or retrofitted CDB) includes an active tap (148), a passive tap (150), a cable modem (132), an electrical locking device (134), sensors (136), at least one bidirectional programmable multitap (BPMT) (138), an access control system (142), an access device reader (144), and a secondary device reader (146). Each of these components is described below.

In one or more embodiments of the invention, the active tap (148) includes functionality to receive a signal from the cable network infrastructure and distribute the signal to one or more components of the CDB (130). In one or more embodiments of the invention, the signal includes power as well as the signal for cable services (e.g., television channels, network communication services, and phone services).

In one or more embodiments of the invention, a passive tap (150) is connected to the active tap (148). The passive tap (150) includes functionality to alter the signal to separate and remove the power from the cable services. The output of the passive tap may be transferred to the BPMT (138) (described below). The passive tap (150) may include one or more outputs. For example, an output cable for the passive tap may exist for each subscriber set (as shown in FIG. 1). As an alternative to the passive tap (150), the BPMT may be designed to perform both the functionality of the passive tap and the functionality of the BPMT (138). In such cases, the CDB (130) does not include a separate passive tap (150).

In one or more embodiments of the invention, the active tap (148) may also be connected to the access control system (142) (described below). Specifically, the output of the active tap (148) may provide the network connection and the power for the access control system (142). In one embodiment of the invention, all components within the CDB (130) are powered using current obtained from the signal received from the active tap (148).

In one embodiment of the invention, the cable modem (132), e.g., DOCSIS (Data Over Cable Service Interface Specification) type modem, receives signal(s) (described above and in FIG. 1) using standard Internet Protocol (IP) communications techniques. The cable modem (132) communicates via the bi-directional data channels established through the coaxial cable network used by the cable company to deliver cable signals to its subscribers. In addition, the CDB (130) may also include a back-up battery (not shown) such as a trickle-charge battery. The back-up battery may be used to provide power to the CDB (130) should a sudden disruption in the normal power source occur.

In one embodiment of the invention, the electrical locking device (134) may include a latching mechanism that is driven by an electrical device, such as a solenoid, actuator, etc. The electrical locking device (134) may be a fail-secure or a fail-safe model depending on the design needs of the CDB (130). The electronic locking device (134) may be an electrical strike, an electromagnetic lock, an electromechanical lock, a mechanical bolt designed to lock and unlock the CDB (130), etc.

In one embodiment of the invention, the electronic locking device (134) may be unlocked using an access device via an access device reader (144) and an access control system (142) (described below) and/or using a secondary device via a secondary device reader (146). In one or more embodiments of the invention, the access device reader (144) is located on the external face on bottom of the CDB (130). Those skilled in the art will appreciate, however, that the access device reader (144) may be located virtually anywhere on the proximity of the CDB (130). In one embodiment of the invention, the access device reader (144) may be a proximity card reader, a swipe card reader, a finger print reader, an eye print reader, a voice recognition device, etc. In one or more embodiments of the invention, the access device reader (144) is used to read access devices (not shown). In one embodiment of the invention, the access device is a device used to store information. Examples of access devices include, but are not limited to, a proximity card, a swipe card, a medium that includes biometric data, etc. In one or more embodiments of the invention, the access device is a chip with a key code (e.g., a 32-bit, a 64-bit, a 128-bit, etc.), which is maintained in a holding container. In one embodiment of the invention, a key code is a code used to represent a collection of information. For example, the code may be an identifier of a service technician (i.e., a service technician key code), address information (i.e., an address key code), and/or a code that may be used for disengaging multiple electronic locking devices by multiple service technicians (i.e., a master key code). For example, the access device may be an electronic key device, such as an IBUTTON® device, which stores a string of bits representing the key code and provides the key code when requested. IBUTTON® is a registered trademark of Dallas Semiconductor Corporation™ located in Dallas, Tex.

In one embodiment of the invention, the access device stores a work log or any other additional information. For example, the access device may maintain a log of each use of the access device.

In one embodiment of the invention, the secondary device reader (146) is a port for a secondary device (not shown). In one embodiment of the invention, the secondary device is a portable device, such as a handheld unit that includes functionality to release the electronic locking device (134). For example, during an initial access to the CDB (130) or in the event of a power failure, the secondary device may be employed. In one or more embodiments of the invention, the secondary device includes an independent power source, an access device reader, a connection mechanism, such as a cable or outlet for the connection, status indicators, and a microcontroller for disengaging the electronic locking device on the CDB (130). The independent power source may be used to provide power to the secondary device as well as to the CDB (130) via the secondary device reader (146). Further, the secondary device reader (146) may also be programmed with a key code. The key code may be a master key code, which may be used for multiple lockboxes and/or service technicians or a key code used to identify a service technician, etc. In one embodiment of the invention, the master key code is an authentication key code that may be used for multiple CDBs. Specifically, the master key code may be used to unlock the electronic locking device (134) on the CDBs. In one embodiment of the invention, the microcontroller includes functionality to obtain a key code from an access device via the access device reader on the secondary device, validate the key code, and provide the master key code to the electronic locking device (134). Alternatively, rather than the secondary device maintaining the master key code, the master key code may be stored on an access device. The access device with the master key code may than be scanned by the access device reader on the secondary device to obtain the master key code.

In one embodiment of the invention, the sensor (140) may correspond to an open door sensor, a motion sensor, a temperature sensor, a power change sensor, a vibration sensor, a shock sensor, a visible light sensor, or any other type of sensor, which may be used to obtain information about the environment in which the CDB is located or the conditions the CDB is experiencing. For example, the sensors may be used to detect whether the door is forced open, a hole is cut into the box, the door is left open, access without using an access device is performed, etc. In one embodiment of the invention, an open door sensor includes functionality to detect when the door of the CDB (130) is open and allows the components of the CDB to be accessible. In one embodiment of the invention, the motion sensor includes functionality to detect motion in and around the CDB (130). In one or more embodiments of the invention, the motion sensor is a passive infrared motion sensor that detects changes in infrared radiation, which occurs when a person or object of a different temperature from surrounding area moves. In one or more embodiments of the invention, the motion sensor has a compact amplifier which may be connected to a microcomputer and supports both analog and digital output.

In addition to the above sensors, the CDB (130) may also include a camera and/or a tamper switch. In one or more embodiments of the invention, the camera is triggered to record a video when any of the sensors is triggered. A tamper switch includes functionality to detect when an individual tampers with the CDB (130).

In one embodiment of the invention, the CDB (130) provides service for a subscribers set via a BPMT (138). In one embodiment of the invention, a service corresponds to content (e.g., cable Television, pay-per view, on-demand television/movie content, local telephone service, long distance telephone service, etc.) and/or an application (e.g., network access to the Internet) provided from the cable head end (or another source). In one embodiment of the invention, each BPMT may serve multiple subscribers. When multiple bidirectional programmable multitaps (BPMTs) are used, the BPMTs may be linked together using daisy chaining or using other configurations that enable multiple BPMTs to be linked to the access control system (142).

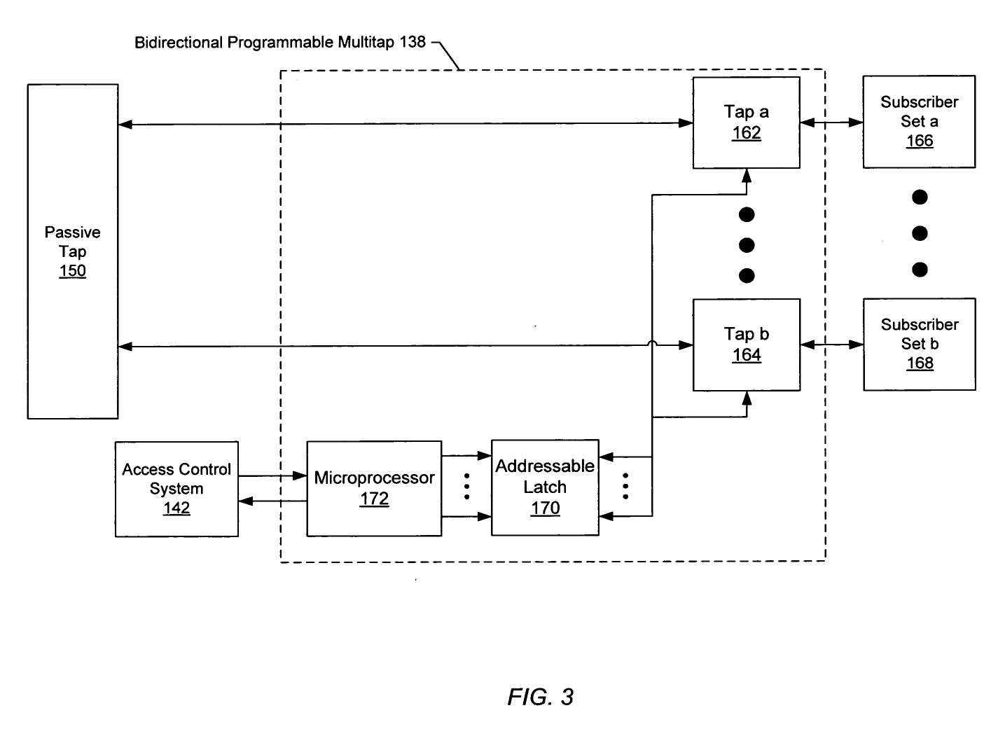

FIG. 3 shows a schematic diagram of a BPMT (138) in accordance with one or more embodiments of the invention. As shown in FIG. 3, a BPMT (138) includes a tap (162, 164) for each subscriber set (166,168), an addressable latch (170), and a microprocessor (172) in accordance with one or more embodiments of the invention.

In one embodiment of the invention, the tap (162, 164) includes functionality to control the flow of signals between the access control system (142) and the subscriber set (166, 168) (e.g., subscriber set (112, 114, 116, 118) described above and in FIG. 1) based on input from the addressable latch (170). The signals may be television signals, signals for the network communication, or any other type of signal used for the transfer of information. Each tap (162, 164) may include a switch (not shown). A switch includes functionality to enable and disable the signal communication between the subscriber set (166, 168) and the passive tap (150). In one or more embodiments of the invention, the switch is a Gallium Arsenide switch. Those skilled in the art will appreciate that other types of switches may be used.

In one or more embodiments of the invention, each tap (162, 164) may also include a filter (not shown). A filter includes functionality to transform the signal prior to the signal reaching the subscriber set (166, 168). For example, the filter may include functionality to remove specific frequencies of the signal. For example, the filter may support tiering to each tap, which allows for enabling and disabling communication according to communication tier. For example, one tier may be associated with basic cable while another tier includes premium sports stations. In one or more embodiments of the invention, the filter is remotely programmable. Specifically, the filter may be controlled (e.g., modified) by an access administration system (described below) via an access control system (described below), the microprocessor (172), and the addressable latch (170). For example, the filter may be a variable digital filter or a variable analog filter that may be remotely adjusted.

In one embodiment of the invention, the addressable latch (170) includes functionality to control each tap (162, 164) individually. Specifically, the addressable latch includes functionality to enable or disable the switch and modify the filter. Thus, subscriber set A (166) may receive a different signal from subscriber set B (168). The input into the addressable latch is controlled by the microprocessor (172). The microprocessor (172) includes functionality to determine the address of the switch that should be open or closed and control the signal to the addressable latch (170).

Those skilled in the art will appreciate that while FIG. 3 shows a configuration in which the BPMT includes a microprocessor, an addressable latch and switches, other configurations are also possible. Specifically, a BPMT may be any type of addressable device that may be used to control communication. Further, in one or more embodiments of the invention, the BPMT receives power, tap connect-disconnect directives, and is monitored by the access control system (142).

Returning to FIG. 2, in one embodiment of the invention, the access control system (142) includes an access control program and access control hardware (not shown), which executes the access control program (e.g., access control software, firmware, or a combination thereof, etc.) (not shown). The access control hardware may include a processor, memory (RAM and/or ROM), and a storage medium, such as a semiconductor or other electronic memory and/or a hard drive. In one or more embodiments of the invention, the processor is at least three separate microprocessors. Specifically, one microprocessor may include functionality to obtain a key code from the access device reader (144). Another microprocessor may include functionality to obtain a key code and power (when required) from the secondary device reader (146). The third microprocessor may be configured to monitor the state of the CDB (130). One skilled in the art will appreciate that more or fewer microprocessors may be used as required.

Additionally, in one or more embodiments of the invention, the access control system (142) includes functionality to separate power from the signal received at the active tap (148) and distribute power to the components of the CDB (130). Thus, for example, the cable modem (132) may have at least two connections to the access control system (142) in which one is used for power and the other is used for data. Similarly, while FIG. 2 shows single connections, the connections between components may vary according to the requirements of the system and the purposes of the connection. Further, while FIG. 2 shows the components as separate, the physical components may be collocated. For example, the cable modem (132) may be a part of the access control system (142). Similarly, in another example, an open door sensor may be connected to the electrical locking device.

The access control system (142) includes functionality to control the BPMT (138), monitor the CDB (130), and allow or prevent access to the CDB (130). Specifically, the access control system (142) includes functionality to transmit a signal to the BPMT to modify particular taps in the BPMT (138), obtain and store status information from the sensor (136), trigger an alert when the status of the CDB (130) changes, monitor the access device reader (144), unlock or lock the electrical locking device (134) based on input to the access device reader (144), and determine whether the electrical locking device (134) is disengaged. The access control system (142) includes functionality to communicate, via a cable modem (132), with an access administration system (120 in FIG. 1).

Returning to FIG. 1, the CDB (108, 110) through the access control system on the CDB (108, 110) is monitored and managed by the access administration system (120), such as via the simple network management protocol (SNMP), transmission control protocol (TCP), user datagram protocol (UDP), etc. Alternatively, other protocols may be used. The access administration system (120) may include functionality to verify authentication information, analyze work logs (manually or automatically), send alerts to administrators indicating potential cable theft at the CDB and/or services, enable and disable individual access devices, track access and usage of the CDB, provide a database of historical information on access and usage of the CDB, generate reports, remotely install firmware on the CDB, monitor the operations of a technician on the cable network infrastructure, etc. In one embodiment of the invention, the access administration system (120) verifies the authentication information using verification information such as a list of enabled access devices, a list of disabled access devices, or any information that may be used to verify the authentication information obtained from the authentication medium.

Additionally, the access administration system (120) may have one or more of the following features: access restriction to prevent unauthorized users from accessing the access administration system; functionality to distribute and control security key codes (e.g., master key code, service technician identification key codes, etc.); functionality to provide rules for service technicians to access lockboxes; encryption functionality (i.e., symmetric, public key code-private key code encryption, etc.) to encrypt and decrypt messages sent between the access control systems and the access administration system in the cable network infrastructure; functionality to indicate whether a CDB has been improperly accessed; functionality to remotely enable/disable an access device; functionality to remotely open a particular CDB in the event that the access device reader and the secondary device reader is malfunctioning; functionality to reset a particular CDB if the access control program is not responding.

Further, the access administration system (120) may also include functionality to control the BPMTs on the CDB (108, 110) via the access control system. Specifically, the access administration system (120) includes functionality to modify remotely the signal to a particular subscriber (112, 114, 116, 118) by modifying the BPMT for the subscriber (112, 114, 116, 118).

The access administration system (120) may include access administration hardware and an access administration program (not shown). The access administration system (120) may be a manned computer system or collection of computer systems located virtually anywhere within the cable network infrastructure (e.g., the cable headend (100), position A in FIG. 1) or outside of the cable network infrastructure and connected, such as via a network, to the cable network infrastructure. Additionally, for increased performance, multiple access administration systems may exist within the cable network infrastructure. For example, one or more satellite access administration system may be connected via a network to the cable network infrastructure to distribute the supervision of the infrastructure. The satellite access administration system may have fewer privileges than other access administration systems in one or more embodiments of the invention. Further, in one or more embodiments of the invention, the access administration system (120) includes functionality to partition the CDBs (108, 110) into zones. A zone is a group of CDBs. For example, a zone may be a particular sub-region of the region that the access administration system services. The CDBs may be grouped into zones according to sub-regions serviced by one or more service technicians.

Those skilled in the art will appreciate that while the present invention uses a cable modem to enable communication between the access control system and the access administration system, communication between the access control system and the access administration system is not limited to cable modems. Thus, depending on the implementation, communication between the access control system and the access administration system may be enabled by a conventional telephone modem, a non-DOCSIS modem, etc.

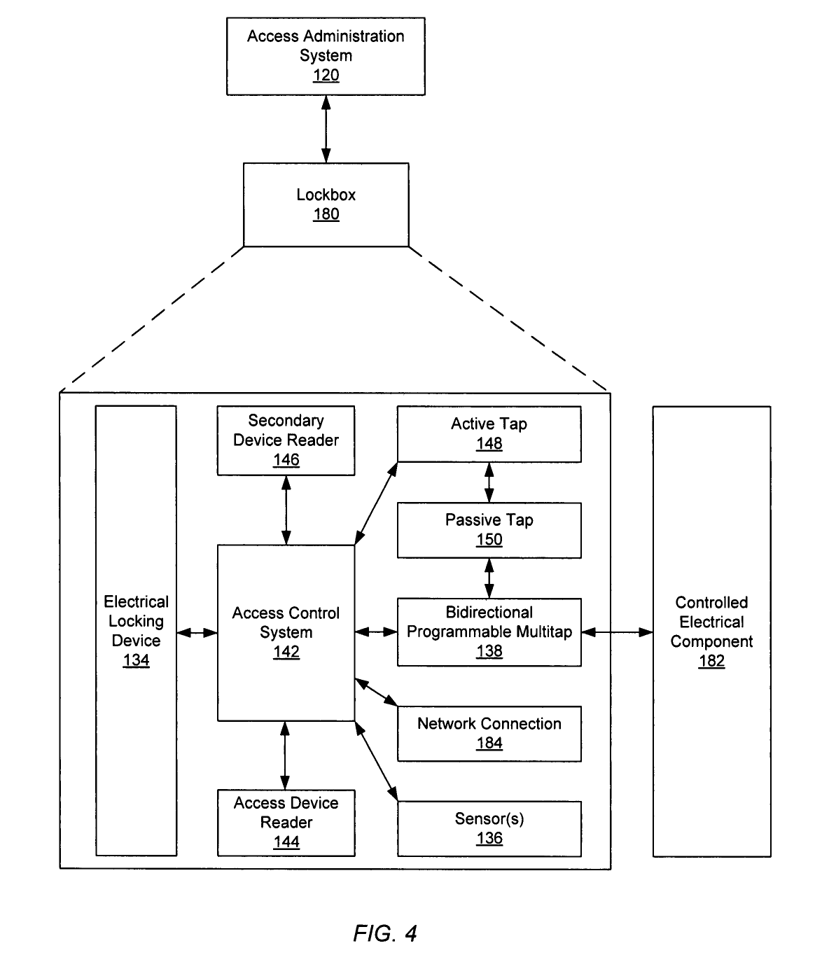

Further, those skilled in the art will appreciate that while FIGS. 1-3 show a schematic diagram of a cable network infrastructure for use with CDBs, one or more embodiments of the invention are also applicable to general lockboxes. For example, FIG. 4 shows an infrastructure for managing a lockbox (180) in accordance with one or more embodiments of the invention. A lockbox (180) is any type of device used to control transmission to a controlled electronic component (182). For example, a lockbox may be a CDB (as discussed above), a traffic signal control box, a box for controlling utilities (e.g., electricity, phone, water, etc.), or any other type of box for which access is restricted. Thus, in the example, the controlled electric component may be the traffic signal, the cable box, electricity system, phone system, water shutoff switch, etc.

In one embodiment of the invention, the BPMT (138) on a lockbox (180) includes functionality to filter and/or disable transmission with the controlled electrical component (182). The BPMT (138) is remotely controlled by an access administration system (120) (described above) via a network connection (184) and an access control system (142) (described above). The network connection (184) is any type of communication system for transmitting and receiving data. For example, the data network connection (184) may be a cable modem, phone modem, a device to interpret data sent on an electric line, a device for receiving and transmitting wireless signals, etc. The connection between the lockbox (180) and the access administration system (120) may be direct or indirect, such as via one or more intermediary devices (e.g., routers, hubs, etc.).

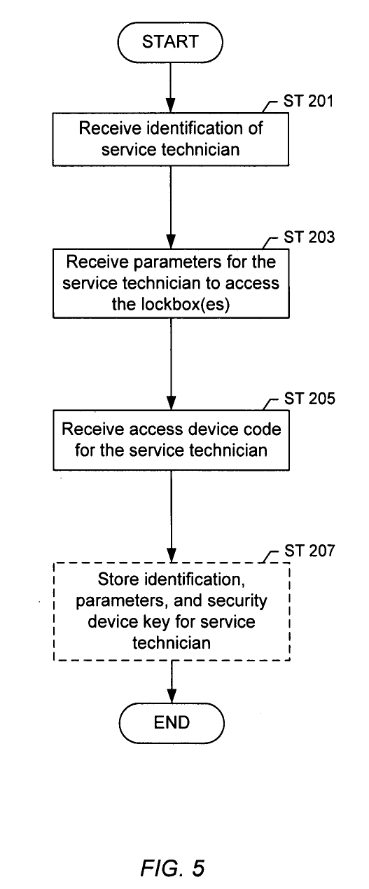

FIGS. 5-9 show flowcharts for managing a lockbox in accordance with one or more embodiments of the invention. While the various steps in these flowcharts are presented and described sequentially, one of ordinary skill will appreciate that some or all of the steps may be executed in different orders and some or all of the steps may be executed in parallel.

FIG. 5 shows a flowchart for adding a service technician to the system in accordance with one or more embodiments of the invention. Initially, identification of the service technician is received (ST 201). The identification may include a unique identifier (e.g., social security number, driver license number, badge number, employee identifier, etc.), address, name, phone number, email address, or any other such identification, which uniquely identifies the service technician. The identification may be received from a service technician directly or indirectly. In response, the user of the access administration system may input the identification into the access administration system using, for example, a graphical user interface of the access administration system.

Further, parameters (access conditions) are received for the service technician to access the lockboxes (ST 203). The parameters may specify one or more particular lockboxes, one or more zones of lockboxes that the service technician is authorized to access, time and days in which the service technician may access a lockbox, etc. The parameters may be submitted to the access administration system in a manner similar to submitting the identification.

In addition to the parameters and the identification, the access device key code (i.e., key code stored in the access device) is received for the service technician (ST 205). The user may submit the access device key code into the access administration system using an access device reader on the access administration system. Alternatively, the user may manually enter the access device key code. Further, rather than providing the access administration system with the key code from the access device, the access administration system may program the access device with the key code.

Once the access device key code, the parameters, and the identification are received for the service technician, the identification, parameters, and access key code are optionally stored (ST 207). Specifically, the data is saved in the access administration system (e.g., in a storage medium located in and/or operatively connected to the access administration system). Alternatively (or additionally), the data may be sent to the lockboxes for which the service technician is authorized to access.

Those skilled in the art will appreciate that while FIG. 5 shows receiving the access device key code, parameters, and identification, any of the aforementioned data may be optionally received. For example, the access administration system may only require the key code and the parameters, only the key code, etc.

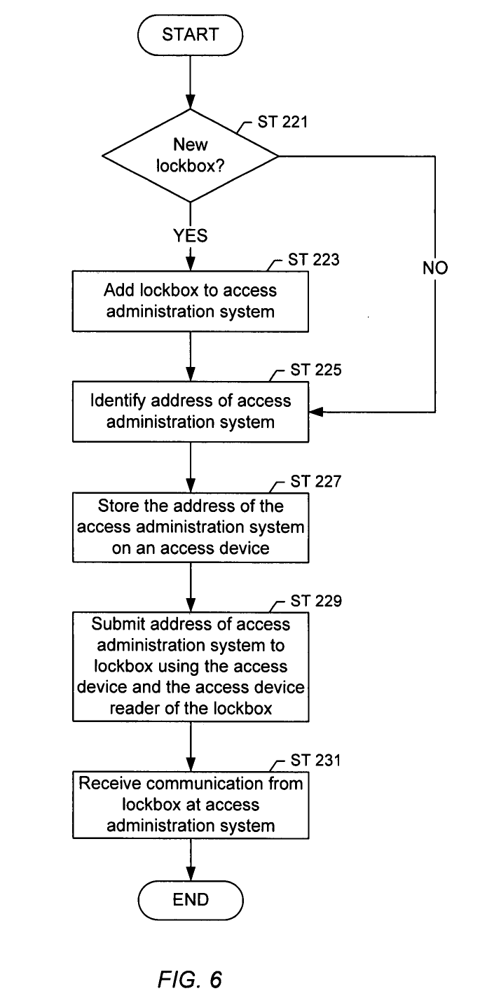

FIG. 6 shows a flowchart for configuring a lockbox in accordance with one or more embodiments of the invention. Initially, a determination is made whether the lockbox is a new lockbox (ST 221). Specifically, a lockbox may be considered a new lockbox when the lockbox has not communicated with the access administration system. For example, the lockbox may be a new lockbox when the lockbox is first retrofitted or installed. The access administration system may track lockboxes in a data repository, such as a database. Thus, determining whether a lockbox is new may be performed by determining whether information about the lockbox exists in the data repository.

If the lockbox is a new lockbox, then the lockbox is added to the access administration system in accordance with one or more embodiments of the invention (ST 223). For example, a user of the access administration system may submit an identifier of the lockbox (e.g., a Media Access Control (MAC) address, serial number, current internet protocol (IP) address, or any other identifier), a location name the location that the lockbox services, configuration information about the lockbox (e.g., number of taps, zone of the lockbox, site of the lockbox, etc.), etc. The details about the lockbox may be stored on the access administration system.

Regardless of whether the lockbox is new, the address of the access administration system is identified (ST 225). The identified address is the electronic address that may be used by the lockbox to communicate with the access administration system. For example, the address may be an IP address, a domain name of the access administration system, another address, or any combination thereof.

Next, the address of the access administration system is stored on an access device (ST 227). The access devices that are stored with the address may be dedicated as address access devices. Specifically, in one or more embodiments of the invention, address access devices store only the address as a key code on the address access device. Further, the appearance of the address access device may be modified, such as color, name, etc., to reflect that the access device is an address access device. When multiple lockboxes are used or when multiple service technicians install lockboxes, multiple address access devices may be created. Thus, for each new configuration of a lockbox, an address access device does not necessarily need to be created prior to configuring the lockbox. The storing of the address of the access administration system may be performed when the access device is first created, such as by a manufacturer, at the access administration system, etc.

Using the access device with the address, the address of the access administration system is submitted to the lockbox (ST 229). Specifically, in one or more embodiments of the invention, the access device reader on the lockbox may scan an access device with the address. Thus, the service technician may use the access device reader on the lockbox and the access device with the address to submit the address to the lockbox. By using the access device, if the address of the administration system changes, then the lockbox may be reconfigured by using an access device with a new address.

For example, if the address is a domain name of the access administration system, then the access control system may request from a domain name service an IP address corresponding to the domain name. The domain name service may respond with the IP address and provide the IP address to the access control system.

Once the access device has the address, the access administration system receives communication from the lockbox (ST 231). Specifically, the lockbox may communicate with the access administration system to send status information, to update the lockbox (e.g., software executing on the lockbox), authenticate a service technician, or perform any other task in which the communication may be used.

While FIG. 6 shows using an access device for configuring a lockbox to communicate with the access administration system, other techniques may also be used. For example, the address of the access administration system may be stored in memory that is located inside the access control system of the lockbox. In such cases, an access device may not be required to add the lockbox to the access administration system. Rather, the access control system may use the address stored in memory to access the access administration system.

Further, the access administration system may be configured with information about the lockbox. The access administration system may periodically attempt to contact the lockbox while the access control system attempts to contact the access administration system. When one of the contacts is successful, communication may be established and the access administration system may complete configuring the access control system and the lockbox.

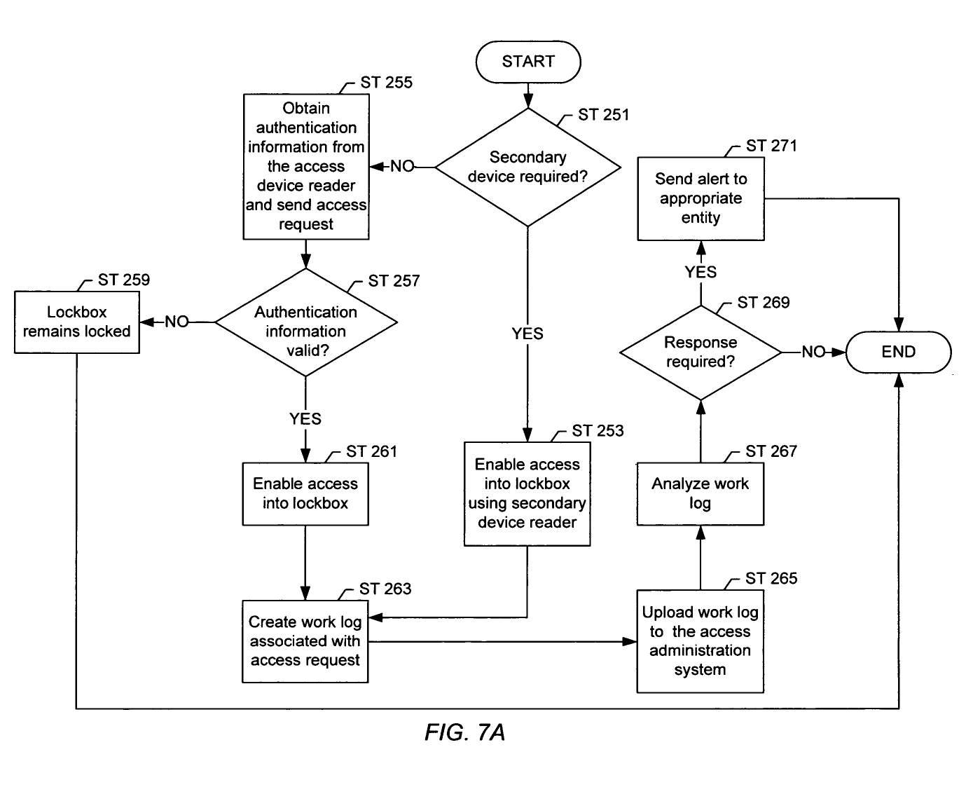

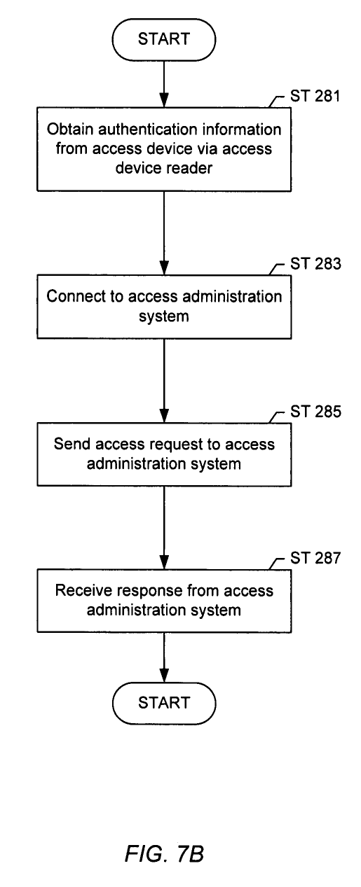

FIG. 7A shows a flowchart of a method for accessing a lockbox in accordance with one or more embodiments of the invention. Initially, a determination is made whether a secondary device is required (ST 251). The secondary device may be required, for example, before the lockbox is enabled at the access administration system, during or after power interruption to the lockbox, when the access control system, modem or access device reader on the lockbox is malfunctioning, etc.

If the secondary device is required, then the access into the lockbox is enabled using the secondary device reader (ST 253).

In one or more embodiments of the invention, an access device reader on the secondary device may scan the access device, which uniquely identifies the service technician, to obtain the identification and/or authorization key code for the service technician. The secondary device may also determine whether the service technician is authorized to access the lockbox by comparing the key code (identification and/or authorization) provided by the service technician with a list of key codes of authorized service technicians or unauthorized service technicians stored in the lockbox, in accordance with one or more embodiments of the invention.

Alternatively or additionally, the access device reader on the secondary device may obtain the master key code using the access device reader from the access device. If the master key code is correct, then the secondary device may indicate to the service technician, such as by visual or an auditory indicator, that the secondary device will begin providing power and/or data to the lockbox.

In one or more embodiments of the invention, the secondary device has a battery and an electrical plug. Thus, if the lockbox requires power, such as when the lockbox is first configured, then the electrical plug between the secondary device and the lockbox (i.e., through the secondary device reader or another component on the lockbox) may be used to transfer the power from the secondary device to the lockbox. Alternatively, the lockbox may be powered by an electrical outlet external to the secondary device and the lockbox.

When the lockbox has power, in one or more embodiments of the invention, the secondary device may provide the master key code and/or the key code identifying the service technician to the lockbox. Upon verification of the master key code, access is granted the lockbox. The access control system may also store information about the master key code and the key code used by the service technician. The stored information may be subsequently supplied to the access administration system.

Alternatively, if the secondary device is not required, then authentication information is obtained from an access device via the access device reader on the lockbox and an access request is sent to the access control system (ST 255). Specifically, the service technician is authenticated in accordance with one or more embodiments of the invention. FIG. 7B shows a flowchart of a method for authenticating a service technician in accordance with one embodiment of the invention. During normal operation, the access control hardware monitors the access device reader.

Referring to FIG. 7B, once an access device has been scanned, the authentication information obtained from the access device is sent, via the access device reader to the access control system (ST 281). In one embodiment of the invention, the information obtained from the access device may include, but is not limited to, the access device holder's name, employee number, unique access key code, an algorithm for generating a response to a challenge request, etc.

The access control system subsequently connects to the access administration system (ST 283). Once connected, the access control system sends an access request to the access administration system (ST 285). One skilled in the art will appreciate that either encrypted or non-encrypted communication may be used. In one embodiment of the invention, the access request includes authentication information (such as information obtained in ST 281), and a lockbox identification number that uniquely identifies the lockbox. A response is subsequently sent from the access administration system back to the access control system (ST 287).

Those skilled in the art will appreciate that the access request may be logged at anytime or numerous times during the authentication process. Further, those skilled in the art will appreciate that the request-response authentication method disclosed in FIG. 7B may be modified to include a challenge-response authentication process, where upon receiving an access request, the access administration system replies with a challenge string prompting the access control program, using information obtained from the access device, to respond to the challenge. In addition, the other authentication methods that use one-time passwords, etc., may be used to authenticate the service technician.

In one embodiment of the invention, each authentication medium (e.g., access device) is assigned to one or more logical groups. Each group includes one or more zones. The aforementioned access model allows a system administrator to assign a particular access device the access privileges of a particular group or groups, rather than having to identify each lockbox that a particular access card can access. However, the aforementioned access model retains the functionality to allow the system administrator to specify, at the lockbox level, which lockbox may be accessed, etc. Those skilled in the art will appreciate that the granularity of access specificity is conditioned upon the individual access policies the system administrator(s) wish to implement and/or maintain.

In one embodiment of the invention, the access request includes authentication information (e.g., a key code stored on the access device, username and/or password, etc.), and a lockbox identification number that uniquely identifies the lockbox. Those skilled in the art will appreciate that if an alternative authentication mechanism is used such as a fingerprint reader, then an access device may not be required for authentication. Further, those skilled in the art will appreciate that added security may result by including password information or public/private key code information on the access device.

Returning to FIG. 7A, the response from the access administration system is used by the access control system to determine whether the obtained authentication information is valid (ST 257). Alternatively, the lockbox may have a local list of enabled and/or disabled access key codes at the lockbox that is updated by the access administration system. The local list may be used by the lockbox to authenticate the service technician.

If the authentication information is not valid, then the lockbox remains locked (ST 259). If the authentication information is valid, then the service technician obtains access to the lockbox (ST 261). Each attempt to access the lockbox is recorded by the access control system in accordance with one or more embodiments of the invention.

Once the service technician has gained access to the lockbox, a work log, as described above, is created that is associated with the access request of the service technician (ST 263). In one or more embodiments of the invention, upon closing of the lockbox (or alternatively, in real-time), the work log is uploaded to the access administration system (ST 265). Depending on the implementation architecture of the access control system, the work log, and any additional information (e.g., the enabled list and/or disabled list) may be “pushed” or “pulled” between the access control system and the access administration system.

At some point in time, the work log is analyzed (ST 267). The analysis may include real-time analysis, automatic analysis, manual analysis, or any combination thereof. The analysis may include review of usage patterns, unauthorized access, unauthorized service, billing reports, etc. Based on the analysis, a determination is made as to whether a response is required (ST 269). The response may include, but is not limited to, disabling an access device, updating the enabled access device list and/or the disabled access device list, notifying the authorities that cable theft is occurring, generating an invoice, generating an efficiency report, etc. If a response is required, then an alert is sent to the appropriate entity (e.g., a user of the access administration system, etc.) (ST 271). Otherwise, if a response is not required, then the work log is stored and no additional action is taken. The alert may be in the form of an email alert, a pop-up alert on the access control program for the operator, a short messaging service (SMS) alert, etc.

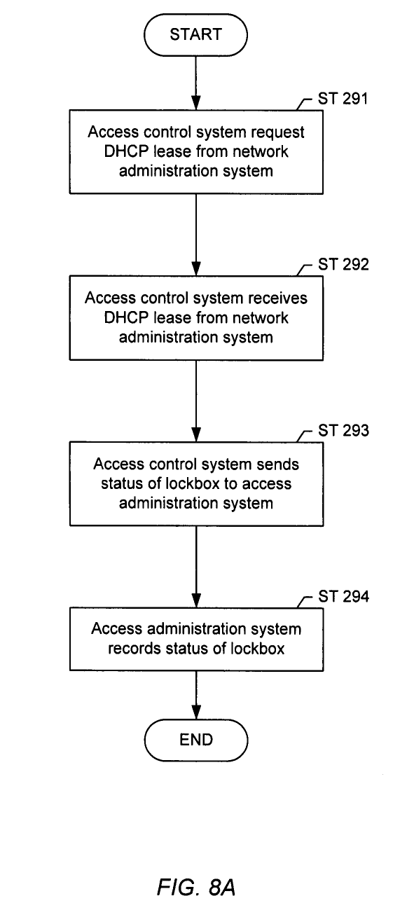

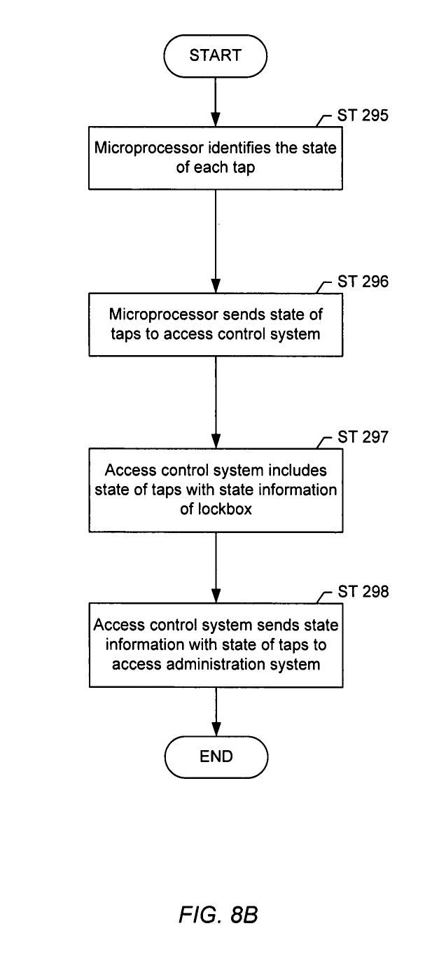

FIG. 8A shows a flowchart for continuous monitoring in accordance with one embodiment of the invention. In one embodiment of the invention, during normal operation, the access control system constantly monitors the status of the lockbox. In order to send status information, if the access control system does not already have an IP address, then the access control system requests a Dynamic Host Configuration Protocol (DHCP) lease from the network administration system (ST 291). The DHCP lease corresponds to a dynamically assigned IP address that is used by the access control system to communicate with the access administration system. The network administration system responds by sending a DHCP lease to the access control system (ST 292). The access control system polls various access control hardware components and various access control program components to determine the status of this particular lockbox and subsequently sends the status to the access administration system (ST 293). Examples of status include open, closed, malfunctioning, etc. The status is then recorded by the access administration system (ST 294).

In one or more embodiments of the invention, the access control system may send status information only when immediate service is required. In such scenarios, the access administration system may respond virtually immediately to the communication from the access control system. Further, the access administration system may continually poll the access control system for status information. The frequency of the polling may be dependent on the number of lockboxes or may be a configurable variable. Alternatively, the access control system may be configured to send periodically status information regardless of whether immediate service is required.

In one embodiment of the invention, the lockbox includes a visual status indicator such as a status light/diode. Thus, while the status of the lockbox is active, as determined by the access control system, the status light/diode, for example, may be green. However, if the status of the lockbox is inactive, as determined by the access control system, the status light/diode, for example, may turn red. Terms “active” and “inactive” are relative terms used to indicate whether the access control system for a particular lockbox is operating normally or the access control system for the particular lockbox is operating incorrectly or malfunctioning.

While FIG. 8A shows obtaining and releasing a lease from the access administration system, in one or more embodiments of the invention, the access control system may obtain and continually renew the DHCP release. Thus, the access control system may maintain the same IP address through multiple status updates. Moreover, when the IP address changes the access control system may contact the access administration system that in turn stores the new IP address. Thus, the access control system and the access administration system may each establish communication as needed. For example, the access administration system may establish communication to change the configuration of the lockbox, download new firmware, ensure that the lockbox is operational, etc.

FIG. 8B shows a flowchart of a method for monitoring the taps. Periodically or during an event of a change, the microcontroller on the BPMT identifies the state of each tap (ST 295). The state of the taps may include information about whether the switch is open or closed and the type of filter on the tap.

In one or more embodiments of the invention, the microprocessor sends the state of each tap to the access control system (ST 296). The access control system may include the state of the taps along with the state information for the lockbox (ST 297). The access control system may send the state information with the state of the taps to the access administration system (Step 298). A user or program at the access administration system may compare the state of the taps with the level of service requested by the subscriber(s) to determine whether a subscriber set connected to a tap is receiving unauthorized service. If the subscriber set is receiving unauthorized service, then the user may send a service technician to the lockbox and/or send a request to the access control system to turn off the switch in the tap.

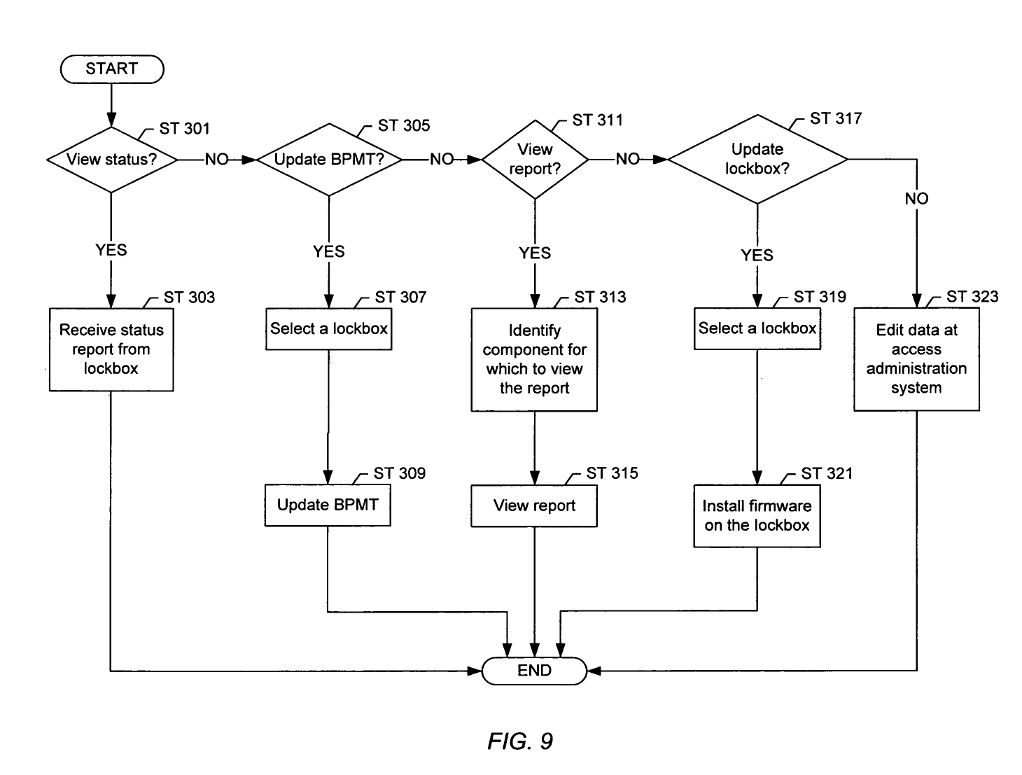

FIG. 9 shows a flowchart of a method for managing the lockbox from an access administration system in accordance with one or more embodiments of the invention. A user using the access administration system may perform different tasks. In one or more embodiments of the invention, the user may determine whether to view status information about the lockbox (ST 301). If the user decides to view status information, then a status report is received from the lockbox (ST 303). The status report may be sent to the access administration system periodically, on demand, or based on a combination thereof. In one or more embodiments of the invention, the information in the status report is configurable. The status report may indicate the status of each component of the lockbox, such as whether the lockbox is open, has been tampered with, whether a component is malfunctioning, etc. Based on the status report, the user may determine whether a technician should be sent to the lockbox or whether the lockbox should be updated using the lockbox administration system (not shown).

As an alternative to or in addition to viewing status information, the user may determine whether to update a BPMT (ST 305). For example, if the lockbox is a cable distribution box, then the user may decide to update a tap of a subscriber when the subscriber requests a change in service, such as requesting service, cancelling service, changing the service level, etc.

If the user determines to update the BPMT, then the user selects a lockbox (ST 307). Specifically, the user may use an interface of the access administration system, identify the zone of the lockbox with the BPMT, and select the lockbox. Next, the user updates the BPMT (ST 309). Updating the BPMT may involve the user selecting the BPMT and the tap within the BPMT. When selecting the tap, the user may select an action to be performed on the tap. For example, the action may be to open or close a switch. Alternatively, the action may be to adjust a filter on the tap. The action is sent as a request to the access control system on the lockbox. In response to receiving the request, the access control system may forward a command to the microprocessor on the BPMT, which uses the action and the address of the tap to send a signal to the addressable latch on the BPMT. The addressable latch may then update the tap according to the action requested by the user.

Continuing with FIG. 9, the user may determine whether to view a report (ST 311). In one or more embodiments of the invention, the user may view a report of all lockboxes, all zones, a subset of lockboxes, technicians, etc. For example, the user may view a report about lockboxes that have been accessed in the past two days or a report about the actions of a service technician.

If the user determines to view a report, then the user identifies a component for which to view the report (ST 313). Specifically, the component may be the lockbox(es), zone(s), site of lockbox, and/or technician(s) for the report. The user may also select parameters for the report, such as a timeframe of events in the report, etc. Next, the user views the report (ST 315). The access administration system gathers the information to generate the report, such as from a database or from the lockboxes, and displays the report for the user in accordance with one or more embodiments of the invention. Alternatively, the access administration system may print the report, send the report to an address (e.g., email address, physical address, fax, or any other such address) specified by the user, etc.

Further, the user may determine whether to update the lockbox in accordance with one or more embodiments of the invention (ST 317). For example, the user may determine whether to download firmware (or software) onto the lockbox or update parameters that the lockbox may use to send status information. If the user determines to update the lockbox, then the user selects a lockbox to update (ST 319). In one or more embodiments of the invention, the user may select multiple lockboxes to update. Next, the user installs firmware (or software) on the lockbox(es) (ST 321). For example, the user may select the firmware (or software) to install on the lockbox and send the firmware (or software) to the access control system. The access control system may then install the firmware (or software).

Continuing with FIG. 9, in one or more embodiments of the invention, the user may edit data at the access administration system (ST 323). For example, the user may edit the types, frequency, address, and number of alerts informing the user of an event. In the example, the user may further modify service technician, site, and zone information, and add notes regarding visits to a site. Those skilled in the art will appreciate that the above discussion of tasks that a user may perform using the access administration system is intended as an example of the possible tasks that the user may perform.

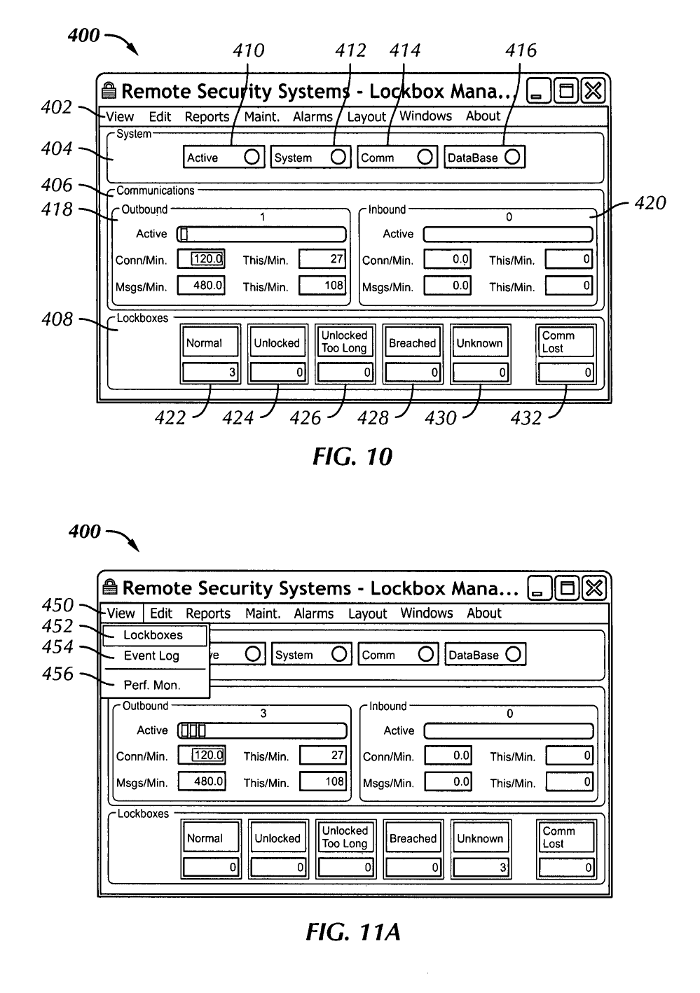

FIGS. 10-17D show example user interfaces in accordance with one or more embodiments of the invention. Specifically, FIGS. 10-17D show example user interfaces of the access administration system that the user may use to manage the system. Those skilled in the art will appreciate that the format, design, and functionality may vary based on the requirements and preferences of the user and lockboxes.

FIG. 10 shows an example manager window (400) for a user to manage the system in accordance with one or more embodiments of the invention. In the example, the management window (400) includes a menu bar (402) for displaying a menu of tasks that may be performed, a system panel (404), a communication panel (406), and a lockboxes panel (408). The system panel (404) shows the user status information. In the example, the status information is displayed as mock light emitting diodes (LEDs) labeled “Active” (410), “System” (412), “Comm” (414), and “DataBase” (416). The Active LED (410) may be used to confirm that the access administrative program is executing. In the example, the Active LED (410) may alternate between green to indicate the program is executing and gray when the program is not executing. The Comm LED (414) indicates whether all, part, or no lockboxes are able to communicate with the access administration system. Specifically, a green indicator may be used to identify that all lockboxes are communicating. Yellow may specify that at least one lockbox is not communicating. Red may be used to specify that no lockboxes are able to communicate. Similarly, the system LED (412) and the database LED (414) identifies whether the access administration system is executing correctly and whether the storage server (i.e., the server that stores information about the lockboxes, sites, service technicians, etc.) is executing correctly.

The communications panel (406), in the example user interface, may be used to provide a measure of the amount of outbound traffic (418) and inbound traffic (420) to the access administration system. The “Com/Min” field identifies a number of connections between the lockboxes and access administration system per minute. The “Msgs/min” field may be used to specify a number of transmits and receive messages that are exchanged between the lockboxes and access administration system per minute. The “this min” field may be used to identify the number of connections or the number of messages in the previous minute.

Continuing with the example, the lockboxes panel (408) shows the number of lockboxes that are active and in normal status (422), unlocked (424), unlocked too long (426), breached (428), status is unknown (430), fails to communicate with the access administration system (i.e., “Comm Lost” (432)). As shown in the example, three lockboxes are in the normal state (422).

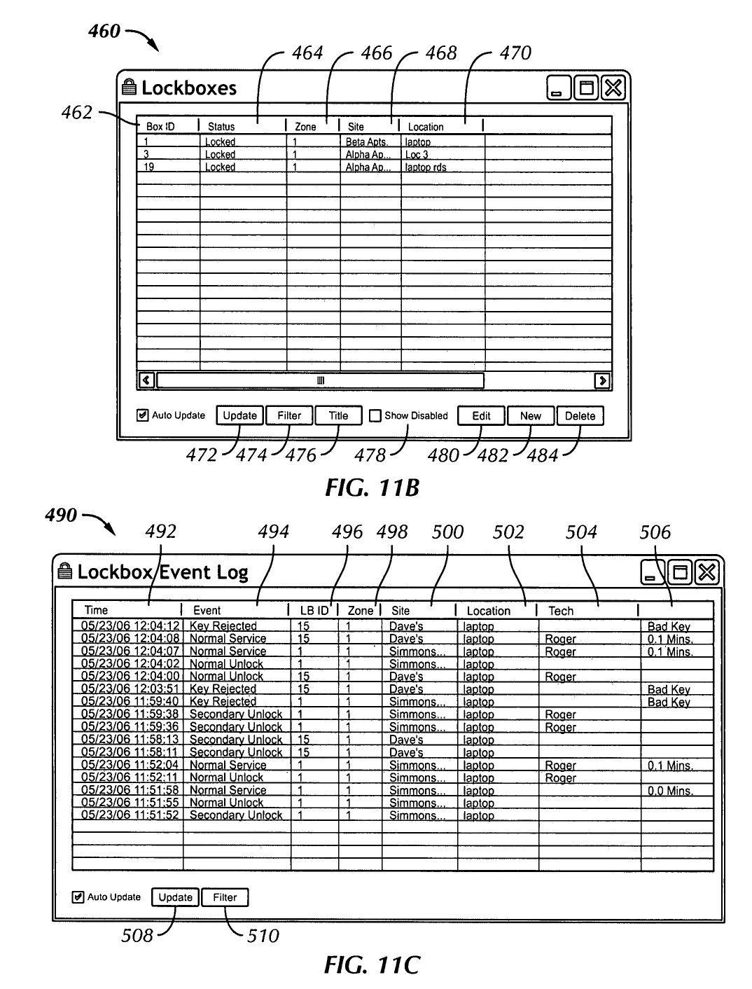

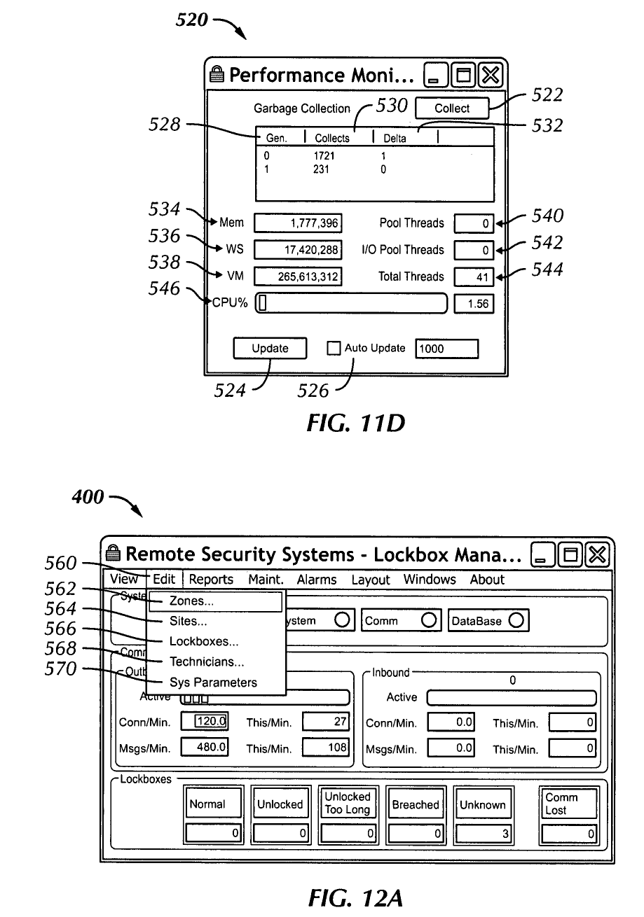

FIGS. 11A-11D shows an example of different windows that a user may view using the access administration system in accordance with one or more embodiments of the invention. As shown in FIG. 11A, a user may select from the view menu button (450) whether to view status information about lockboxes (452), an event log (454), or a performance monitor (456) from the manager window (400).

FIG. 11B shows an example lockbox window (460) for a user to view status information about the lockboxes in the system. As shown in the example, status information may include a one line entry for each lockbox in the system. In the example, the status information is stored in a column format, where the columns include an identifier of the lockbox (462), the current status of the lockbox (464), the zone in which the lockbox may be found (466), a site that is serviced by the lockbox (468), and the location of the lockbox (470). From the lockbox window (460), a user may select to update (e.g., refresh) the list of lockboxes (472) to view new status information. The user may also select to filter the lockboxes that are shown (474), such as to confine entries to specific types of recorded activity, activity in specific zones, or activities occurring within specific time intervals. In the example, multiple lockbox windows, each with a different set of filters, may be simultaneously displayed. Thus, a user may select to re-title a lockbox window with a specific set of filters by selecting the title button (476). Alternatively, the user may select to show disabled lockboxes (478) in addition to enabled lockboxes, edit administrative information about an existing lockbox (480), add a new lockbox (482), or delete a lockbox (484). Further, the user may select a lockbox from the list of lockboxes to view more detail, request communication contact, download firmware, and reconfigure the lockbox.

Continuing with the view menu (450 in FIG. 11A), from the manager window, a user may request a view of the event log. FIG. 11C shows an example event log window (490) in accordance with one or more embodiments of the invention. The event log window (490) may be used to alert the user to events in the system. The events recorded in event log may be displayed in a column format, where the columns include the time and date of the event (492), an identifier of the event (494), an identifier of the lockbox at which the event occurred (496), zone at which the event occurred (498), site at which the event occurred (500), and location at which the event occurred (502), the service technician causing/associated with the event, if applicable, (504), and a note about the event, if available (506). As shown in the example, the user may determine that on May 23, 2006, a key code was rejected for a lockbox with an identifier of 15 because the key code was a bad key code. Further, using the event log window (490), the user may select to update the list of events (508) and filter the list of events (510). For example, the user may filter the list of events by the type or severity of the event, the service technician causing (or associated with) the event, etc.

FIG. 11D shows an example performance monitor window (520) that may be displayed when selected from the view menu of the manager window in accordance with one or more embodiments of the invention. The performance monitor window (520) may be used to identify the amount of resources that the access administration system is using. For example, the user may select a collect button (522) to begin garbage collection of unused memory. The user may select an update button (524) to manually update the performance monitor and select an auto update option (526) with a frequency value to update automatically the performance monitor. The example performance monitor window (520) may also provide a table of the types of collection. For example, values in the generation column (528) may be used to specify whether the row is for memory that is easy to recover and the memory that is hard to recover. A collects (530) column may be used to indicate a number of garbage collection sweeps. A delta column (532) may be used to specify the different number of sweeps since the previous collection.

The performance monitor window (520) in the example, also displays statistics about the execution of the access administration system. For example, the performance monitor window (520) identifies the amount of random access memory in use (534), the amount of the program in the working set of memory (536), the range of addresses of virtual memory (538) that can be accessed, the proportion of the processor in use (546), the amount of threads that are in use (540), the amount of input and output threads in use (543), and the total number of threads in use (546).

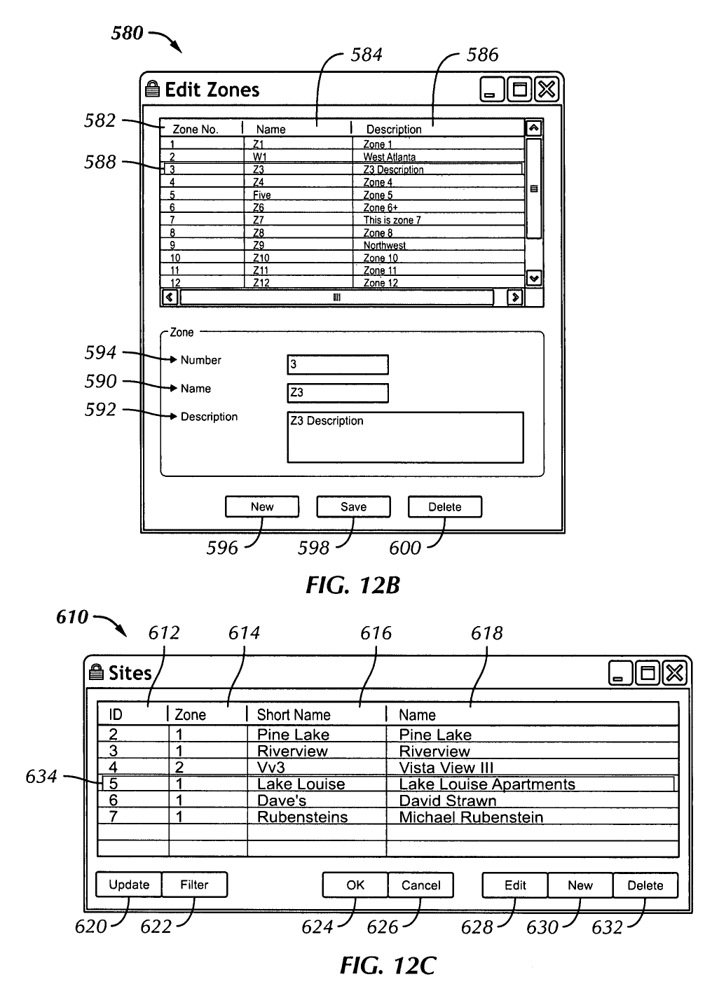

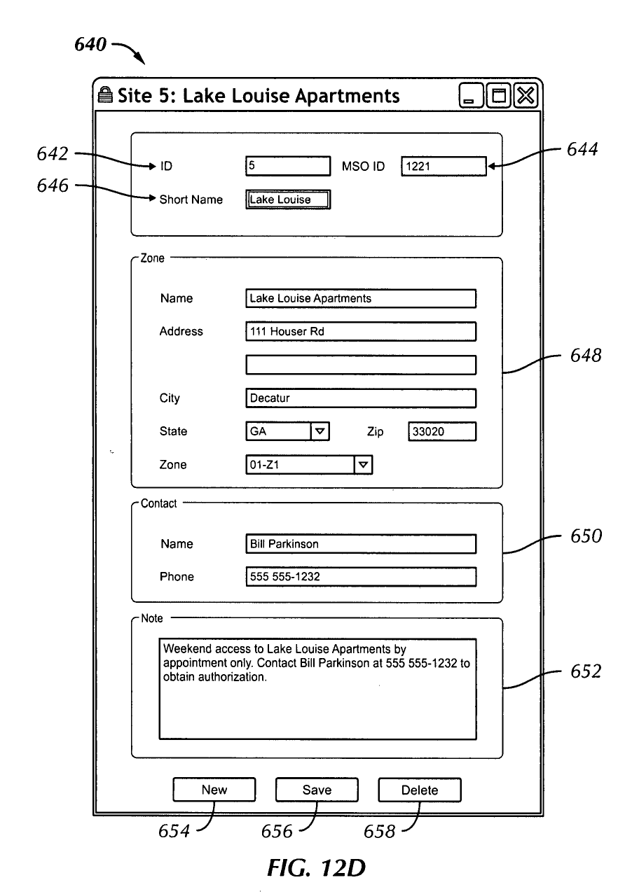

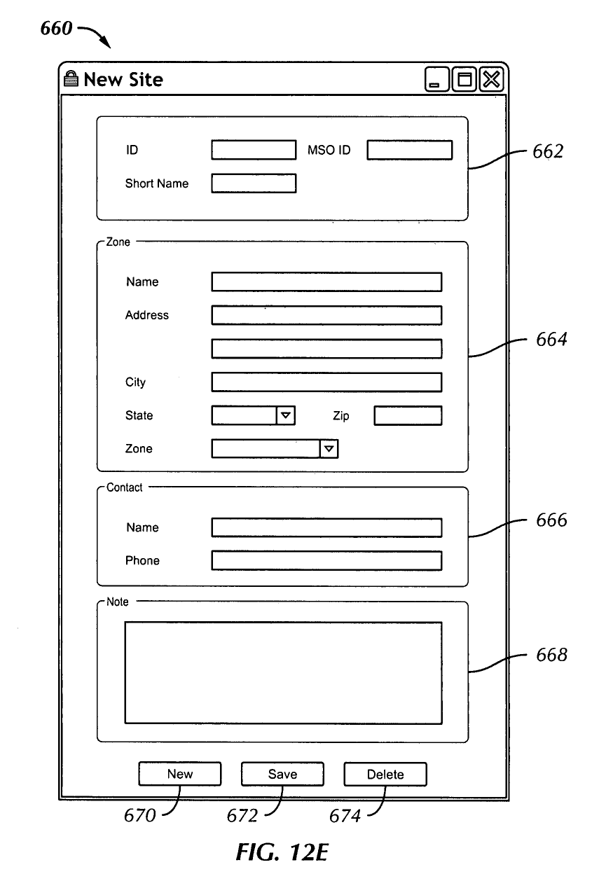

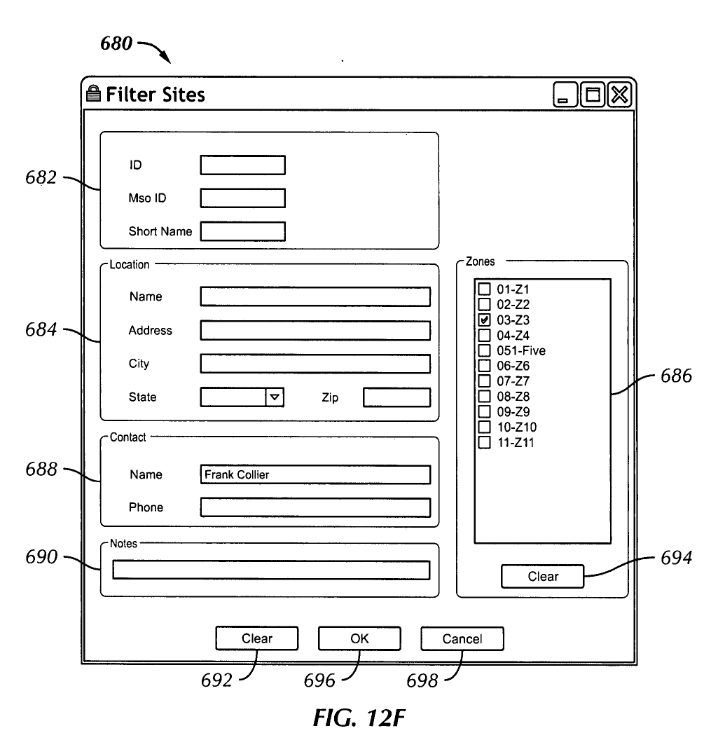

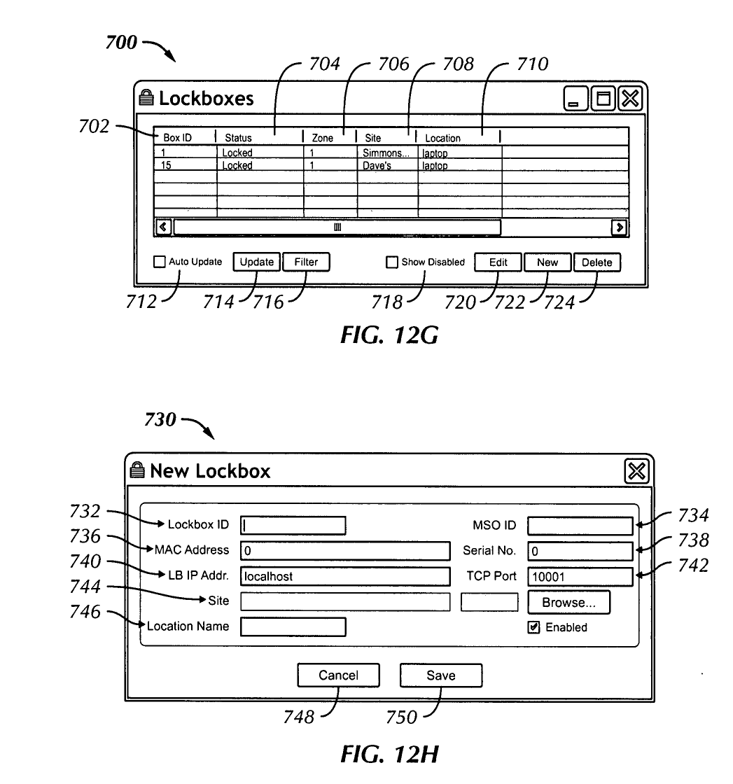

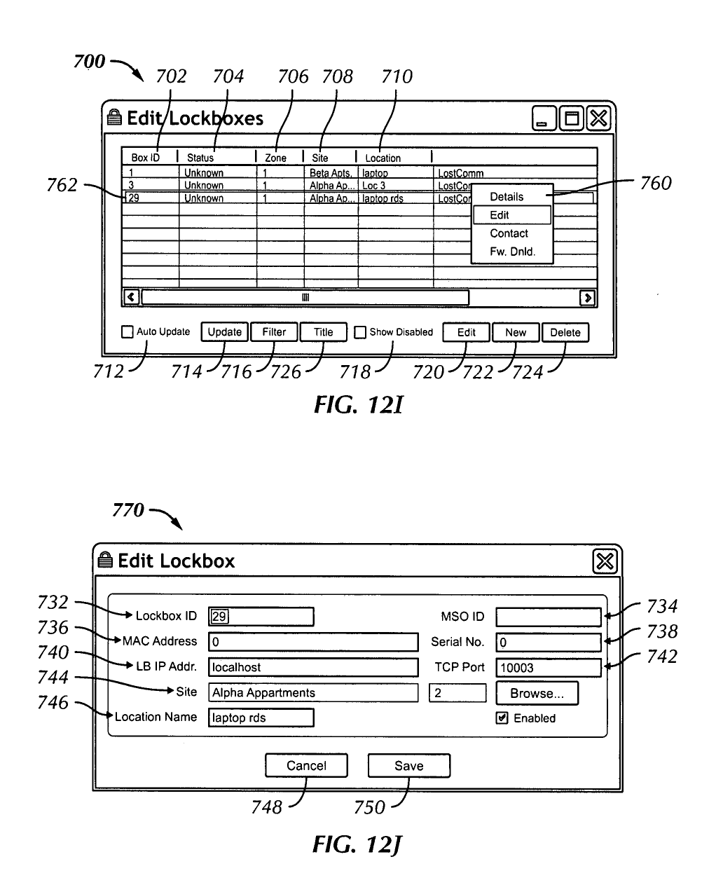

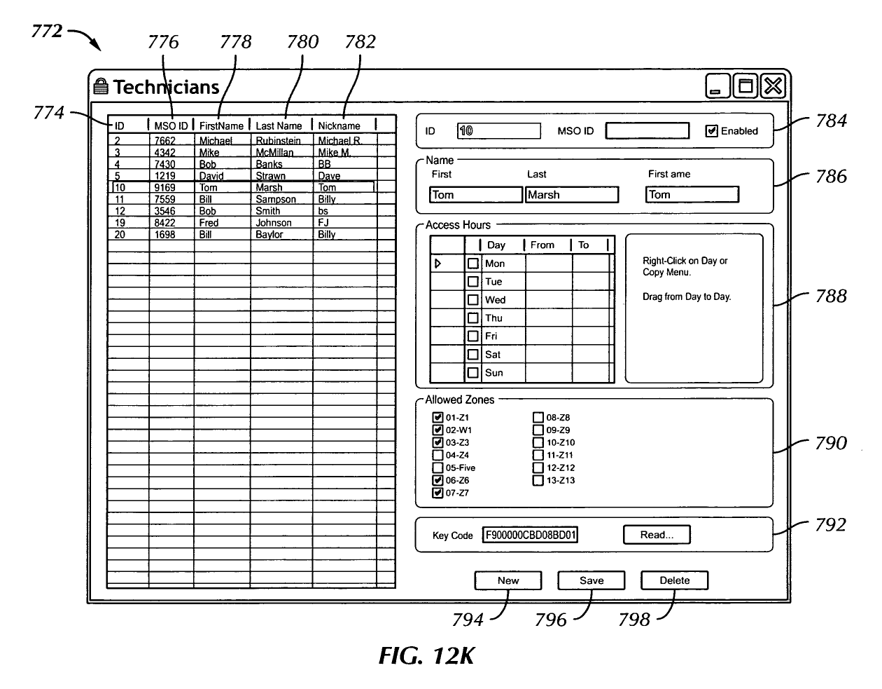

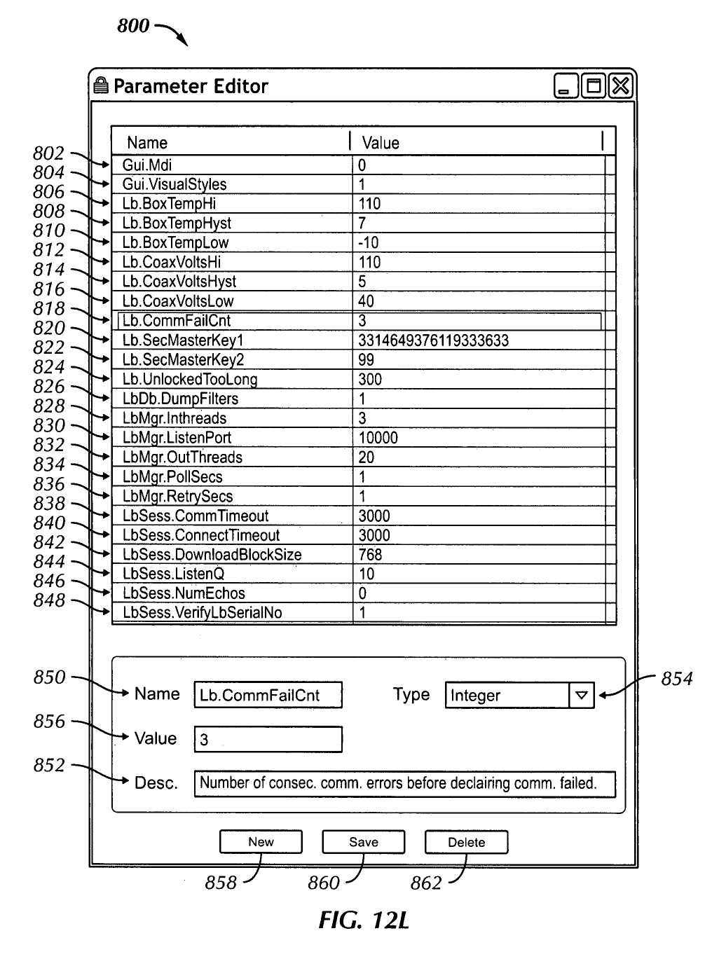

In addition to viewing information, the access administration system may also be used to edit information in the example. FIGS. 12A-12L show example windows that a user may use to edit information in the access administration system. In one or more embodiments of the invention, each user of the access administration program may have different access privileges. Thus, the information that may be edited may be dependent on the access privileges of the user. FIG. 12A shows the example manager window (400) when the edit menu (560) is selected. As shown in FIG. 12A, a user may select from the edit menu (560) to edit information for zones (562), sites (564), lockboxes (566), technicians (568), and system parameters (570).

For example, if a user selects the edit information of zones option (562), then the edit zones window may be displayed to allow the user to edit a zone. FIG. 12B shows an edit zones window (580) that may be displayed. As shown in FIG. 12B, the user may view a list of zones that include the zone number (582), the name of the zone (584), and a description of the zone (586). When the user selects a zone, information about the zone is displayed in the example window in an editable format. In FIG. 12B, the user has selected zone 3 (588). After selecting zone 3, the user may change the name (590) of the zone and the description of the zone (592). Further, using the edit zones window (580), the user may select a button to add a new zone (596), save the newly edited information (598), or delete a zone (600).

Next, consider the scenario in which the user desires to edit a site in the example. FIG. 12C shows an example sites window (610) that may be used to edit information about a site in one or more embodiments of the invention. In the example, the sites window displays the sites that are in a data repository and of the access administration system. Using the sites window (610), a user may select a site based on the site identifier (612), zone (614), a short name for the site (616), and/or a full name for the site (618). Further, the user may select buttons for updating the list of sites (620), filtering the list of sites according to a search criterion (622), returning to the main screen, accepting edits (624), canceling edits (626), editing a site (628), adding a new site (630), or delete a site (632). In the example, consider the scenario in which the user desires to edit the site with the name, “Lake Louise Apartments.” Accordingly, the user may highlight the site (634) and select the edit button (628).

After selecting the edit button, the user is navigated to an edit site window. FIG. 12D shows an example edit site window (640) in accordance with one or more embodiments of the invention. As shown in FIG. 12D, a user may edit the site identifier (642), the identifier used by a multi-service operator (MSO) (644), the short name (646), the location information (648), the contact information (650), and/or the notes (652) about the site. Further, a user may select a button to create a new site (654), save the edits (656), cancel the edits and/or return to the sites window (658). If the user selects the button to create a new site (654), then the example user interface may navigate the user to a new site window.

FIG. 12E shows an example new site window (660) in accordance with one or more embodiments of the invention. As shown in FIG. 12E, a user may submit site identification information (662), location information (664), contact information (666), and notes (668). Further, the user may select a button to create a new site (670), save the new site (672), or cancel the creation of the new site (674).

FIG. 12F shows an example filter sites window (680) that may be displayed when the user selects a filter button to filter the list of sites in accordance with one embodiment of the invention. As shown in FIG. 12F, the user may filter the sites displayed based on an site identification information (682), a location (684), one or more zones (686), contact information (688), and/or notes about the site (690). Further, the user may select a button to remove the filtering requirements (692), remove the selections for zone requirements (694), submit the filter requirements (696), or cancel the filter (698).

Alternatively, a user may select an edit menu option to edit information about lockboxes from the manager window in the example user interface. FIG. 12G shows an example edit lockboxes window (700) that may be displayed when a user selects to edit information about lockboxes. As shown in FIG. 12G, a user may view a list of existing lockboxes that are known to the access administration system according to an identifier of the lockbox (702), status information about the lockbox (704), the zone of the lockbox (706), the site in which the lockbox is located (708), and the location of the lockbox (710).

Further, in the example edit lockboxes window, a user may select to auto update the contents of the window, manually update the contents of the window (714), filter the lockboxes displayed in the window (716), show disabled lockboxes (718), edit a lockbox (720), create a new lockbox (722) in the data repository to allow the access administration system to recognize a new lockbox, or delete an existing lockbox (724).

For example, if the user decides to create a new lockbox, then a new lockbox window may be displayed. FIG. 12H shows an example new lockbox window (730) that may be displayed upon the selection of the user. As shown in FIG. 12H, a user may submit a lockbox identifier (732), an MSO identifier (734), a media access control (MAC) address (736), a serial number (738), an IP address (740), a TCP port (742), a site name of the lockbox (744), and a location name of the lockbox (746). In one alternative, the lockbox identifier may be automatically assigned by the access administration system. Further, the user may cancel the creation of the lockbox (748) or save the information about the lockbox (750).

Returning to the edit lockboxes window, FIG. 12I shows an edit lockboxes window (700) in which a user selects a lockbox (e.g., the lockbox with box id 29 (762)) and requests to edit the lockbox by right-clicking on the lockbox. The user may also provide a title for the edit lockboxes window by selecting a title button (726). Upon the right-clicking, a menu from which a user may select an edit option (760) is displayed.

FIG. 12J shows an example window to edit a particular lockbox (770) when the edit option is selected. As shown in the example window (770), the window to edit the lockboxes may have the same fields as the window to create a new lockbox (shown in FIG. 12H). However, the fields shown in FIG. 12J include values previously associated with the lockbox.

Continuing with the editing menu of the manager window, FIG. 12K shows an example technician window (772) that may be displayed when the user selects to edit information about a service technician from the editing menu of the manager window. As shown in the example, the user may view a list of service technicians recognized by the access administration system according to the service technician identifier (774), MSO identifier for the service technician (776), first name (778), last name (780), and nickname (782) for the service technician. Further, in the example, a user may edit the identifier (784), names (786), and hours that the service technician has permission to access a lockbox (788). The user may also edit the zones that the service technician may access (790) and submit a key code for an access device using an access device reader at the access administration system (792). Additionally, the user may store new information about a new service technician (794), save changes (796), and delete information about a service technician (798).

Using the edit menu from the manager window, a user may also edit system parameters. FIG. 12L show an example edit system parameters window (800). In the example, a user may view a list of system parameters and current values for each parameter. For the Graphical user interface, the user may adjust the multiple document interfaces (802) and the visual style (804) to change the look and feel of the screen. For the lockbox, the user may adjust a high temperature threshold (806), a fluctuation range (808) to define the fluctuation in the temperature before a high temp or low temp message is sent, a low temperature threshold (810), a high voltage threshold (812), a fluctuation range for the voltage (814), a low voltage threshold (816), a communication failure error count before a report is sent (818), a secondary access unit master key code (820, 822) to disengage the electronic locking device using a secondary access unit, the amount of time the lockbox is unlocked before it is unlocked too long (824), and a value to indicate whether to debug (826). Additionally, the access administration system may also include parameters, such as a number of simultaneous incoming connections allowed (828), the port to listen for incoming communication (830), the number of simultaneously outgoing connections (832), the amount of polling per second (834), the seconds between attempts to contact an access control system (836), etc. Further, sessions may also have system parameters that may be modified, such as a communication timeout which identifies the number of seconds before a determination is made that communication is lost with the lockbox (838), a time limit in which a determination is made that a connection has failed (840), the block size used to download firmware (or software) files to the Lockbox controllers (842), the number of threads that may be in a listen queue (846), number of echoes for testing purposes (846), and whether to verify the serial number of a lockbox (848).

In order to modify a system parameter in the example, the user may select the system parameter, view the name of the parameter in the name field (850) and a description of the parameter (852), and modify the data type (854) and the value (856) of the parameter. Further, the user may create a new parameter (858), save the edits (860), or delete the parameter (862).

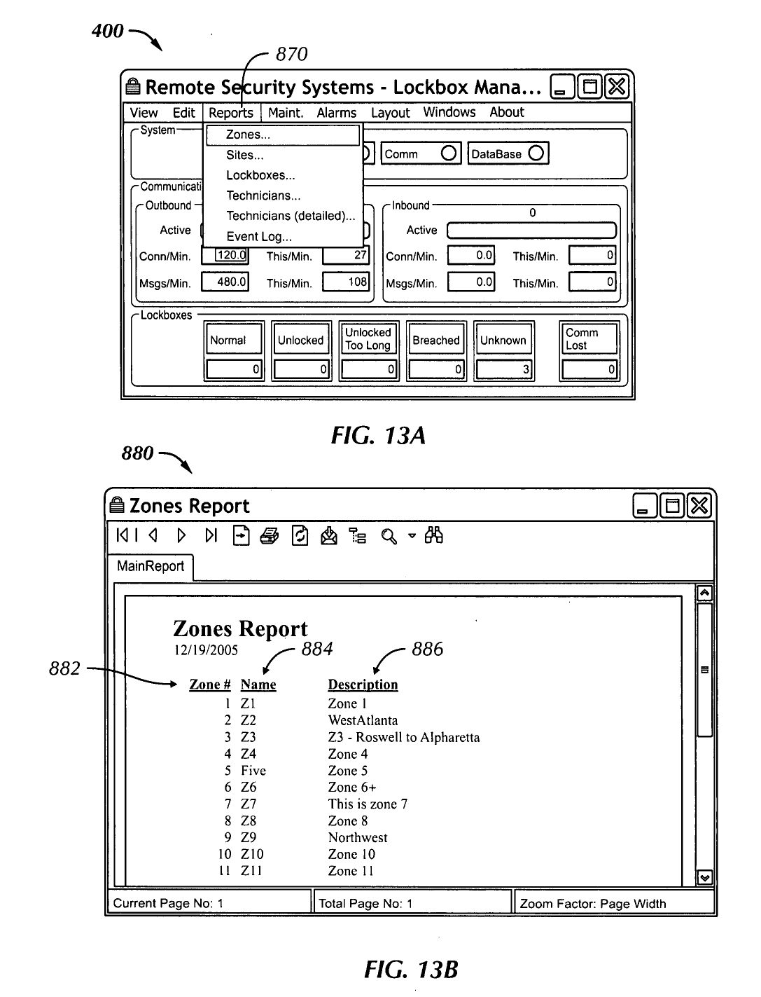

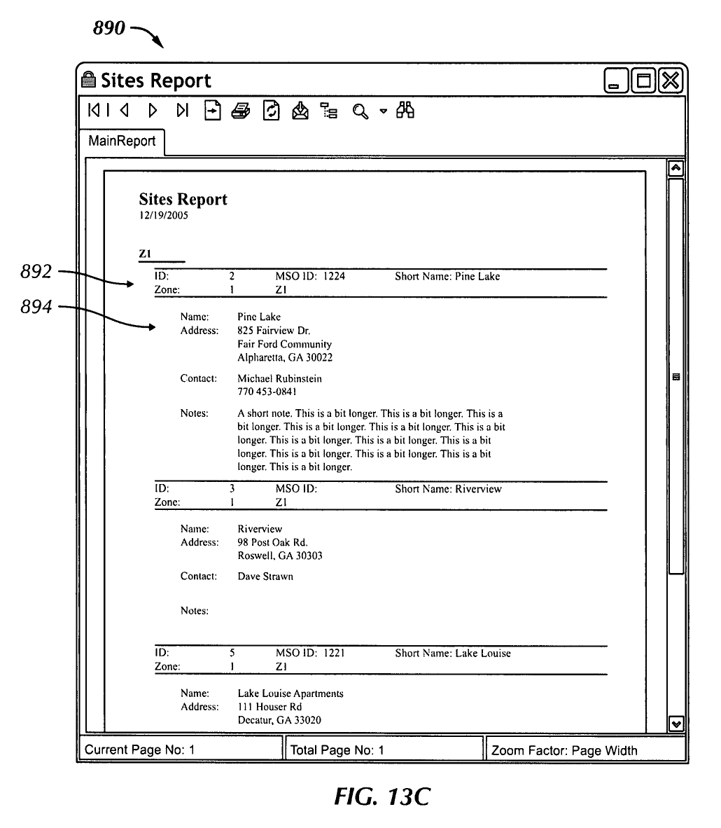

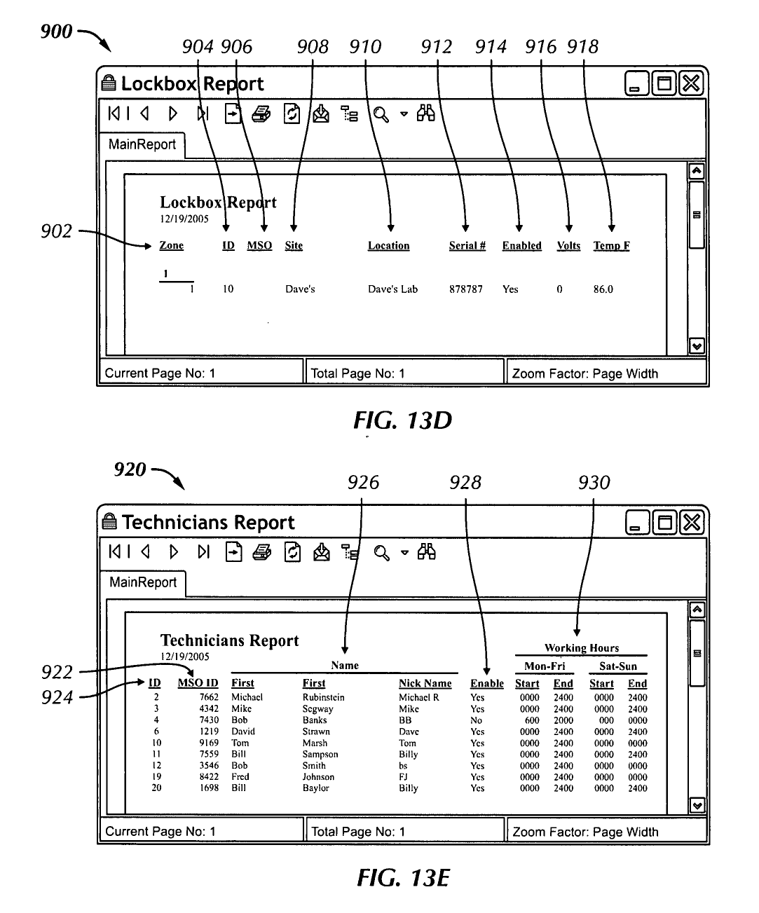

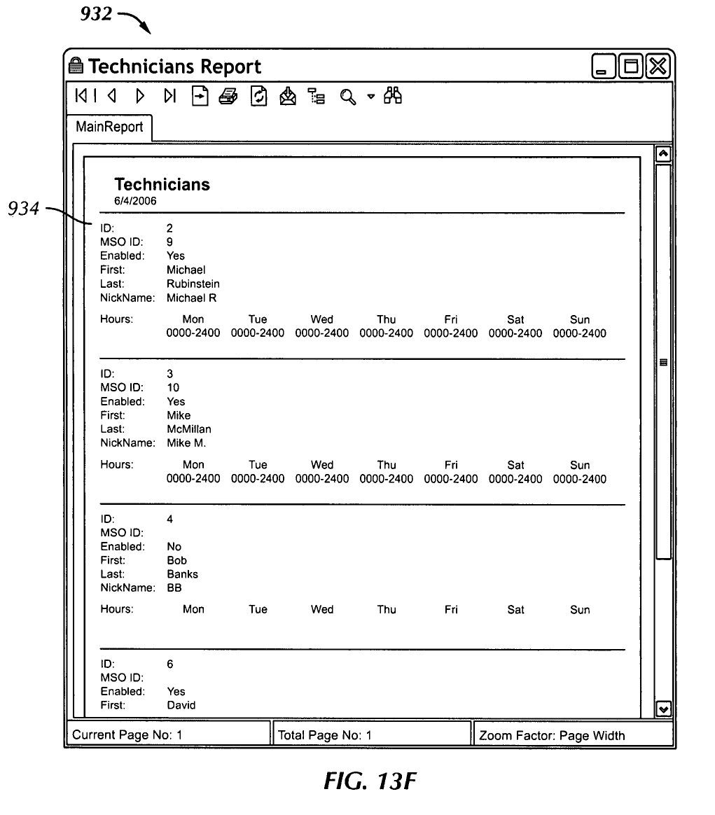

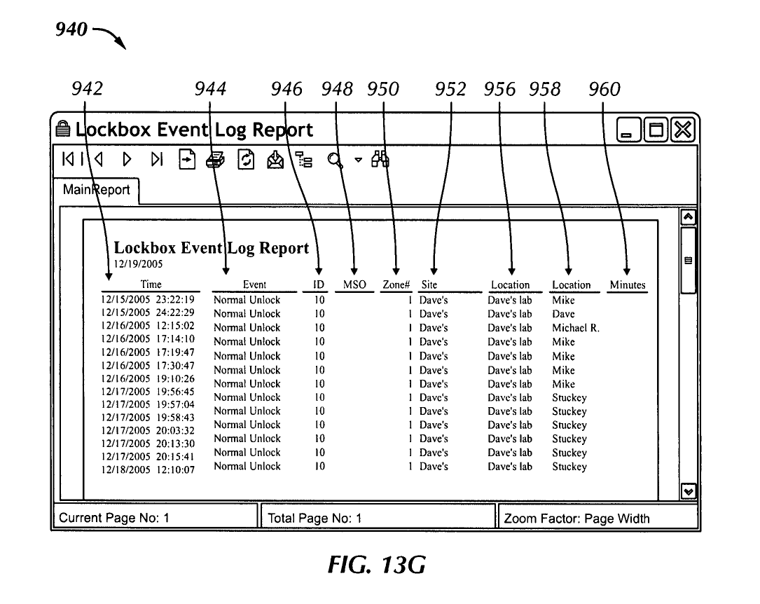

Returning to the manager window, the user may also use a reports menu to view reports. FIGS. 13A-13G show example user interface for viewing different reports. FIG. 13A shows an example reports menu (870) in the manager window (400). As shown in the example, the user may view a report for the zones, sites, lockboxes, technicians, a detailed report of technicians and an event log. Once a report is displayed, a user may print, save, send, and examine the report for accounting and other purposes. Further, in the example, the items displayed in the report may be filtered using the same (or similar) filter criteria discussed above.

FIG. 13B shows an example zones report window (880) that is displayed when the zones menu option is selected from the manager window. As shown in the example zones report window (880), the zones report may display the zone number (882), name (884), and a description (886) of zones known to the access administration system.

FIG. 13C shows an example sites report window (890) that is displayed when the sites menu option is selected from the manager window. As shown in the example, the sites report may be used to show identifiers for the site (892) as well as name, contacts, and notes about the site (894) for each site known to the access administration system.

FIG. 13D shows an example lockbox report window (900) that may be used to display a report about the lockboxes known to the access administration system. As shown in the example, the report may include a zone identifier (902), lockbox identifier (904), MSO identifier for the lockbox (906), site name (908), location of the lockbox (910), serial number of the lockbox (921), whether the lockbox is enabled (916), the amount of volts used by the lockbox (916), and the temperature of the lockbox (918).

FIG. 13E shows an example service technician report window (920) that may be used to display information about service technicians. As shown in the example, the report may include, for each service technician, the identifier of the service technician for the access administration system (922), an MSO identifier (924), a name (926), whether the access device of the service technician is enabled (928), and the working hours for which the service technician has permission to access a lockbox (930). FIG. 13F shows an example detailed service technician report (932) which may, in addition to the information for the previous report, show the hours on a per day basis (934) that the service technician may access the lockbox.

FIG. 13G shows an example lockbox event log report (940) which displays events that have occurred on lockboxes. Specifically, the event log report may include, the time of the event (942), name of the event (944), identifier (948), MSO identifier (950), zone number (952), site (954), and location (956) of the lockbox, as well as the name of the service technician causing the event, if exists, (958) and the duration of the event (960). In one or more embodiments of the invention, the information displayed in the reports may be filtered and modified according to the preferences of the user, parameters, use of the lockboxes, etc.

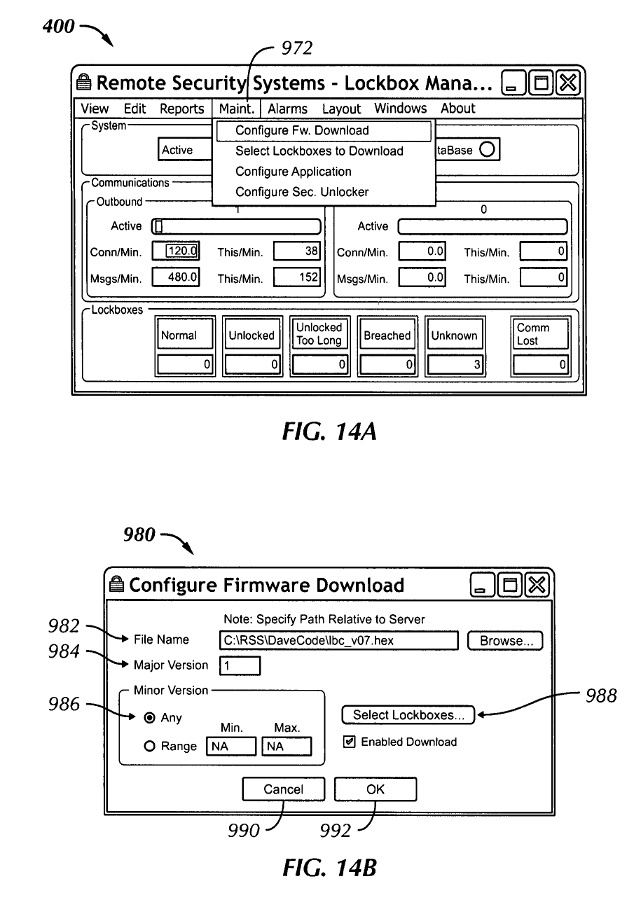

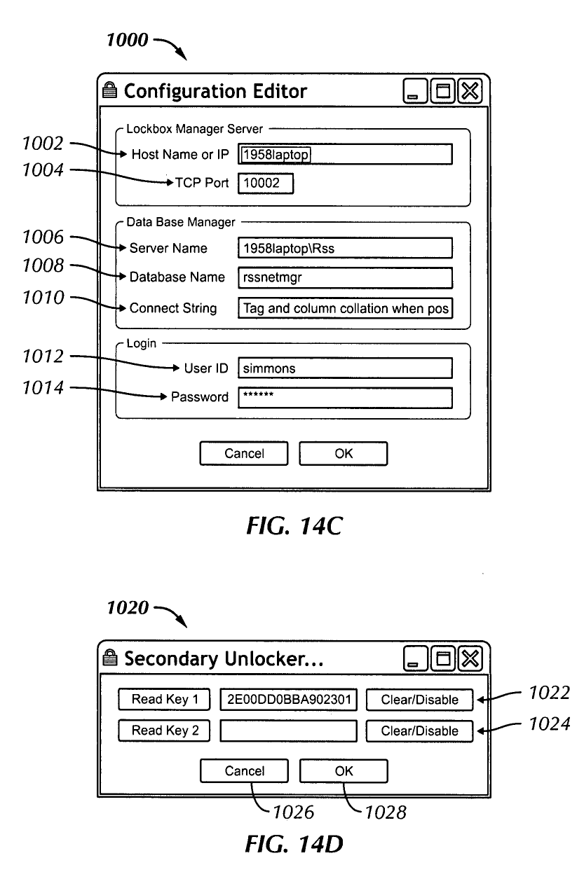

In addition to generating reports, a user may also perform maintenance operations remotely on the lockbox. FIGS. 14A-14D show example user interfaces for performing maintenance operations. FIG. 14A shows an example manager window (400) when the maintenance menu (972) is selected. As shown in FIG. 14A, a user may configure firmware (or software) download to the lockboxes, select lockboxes to download firmware (or software), configure the access administration system, and configure the secondary device unlocking key codes.

FIG. 14B shows an example configure firmware (or software) download window (980) for configuring the access administration system to update the lockboxes. As shown in FIG. 14B, the user may select the file name of the firmware (or software) (982), the version number of the firmware (or software) (984), the minor version of the firmware (or software) (986) and select lockboxes to which to download the firmware (or software) (988). Further, the user may select okay (992) to install the firmware (or software) or cancel (990), thereby not installing the firmware (or software).

Continuing with the maintenance, FIG. 14C shows an example configuration window (1000) for configuring the access administration system. As shown in the example, the IP address (1002) and TCP port (1004) of the access administration system may be modified. Further, the user may modify the storage parameters, such as the server name (1006) of a database server, the name of the database (1008), and a connection string (1010) for connecting to the database. In the example, a user may edit an identifier (1012) and password (1014) for specifying connection parameters for use by another server. Specifically, in one or more embodiments of the invention, multiple users may simultaneously use the access administration program and connect to a server using one or more client computer systems. The server may be used to communicate with the lockbox.

Continuing with the example, FIG. 14D shows an example configure secondary device unlocking window (1020). As shown in the example secondary device unlocking window (1020), the user may update the primary master key code (1022) and secondary master key code (1024) used by the secondary device reader to unlock the electronic locking device. For example, the user may use an access device reader attached to the computer system to enter the master key code. Further, the user may select cancel (1026) to discard changes to the master key code or okay to save the new key code (1028).

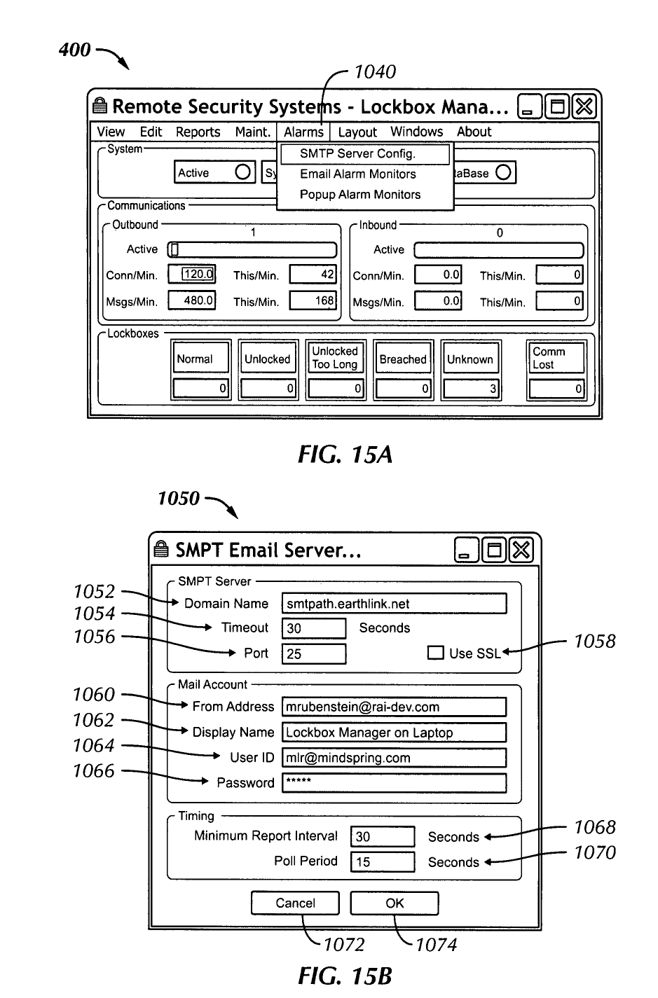

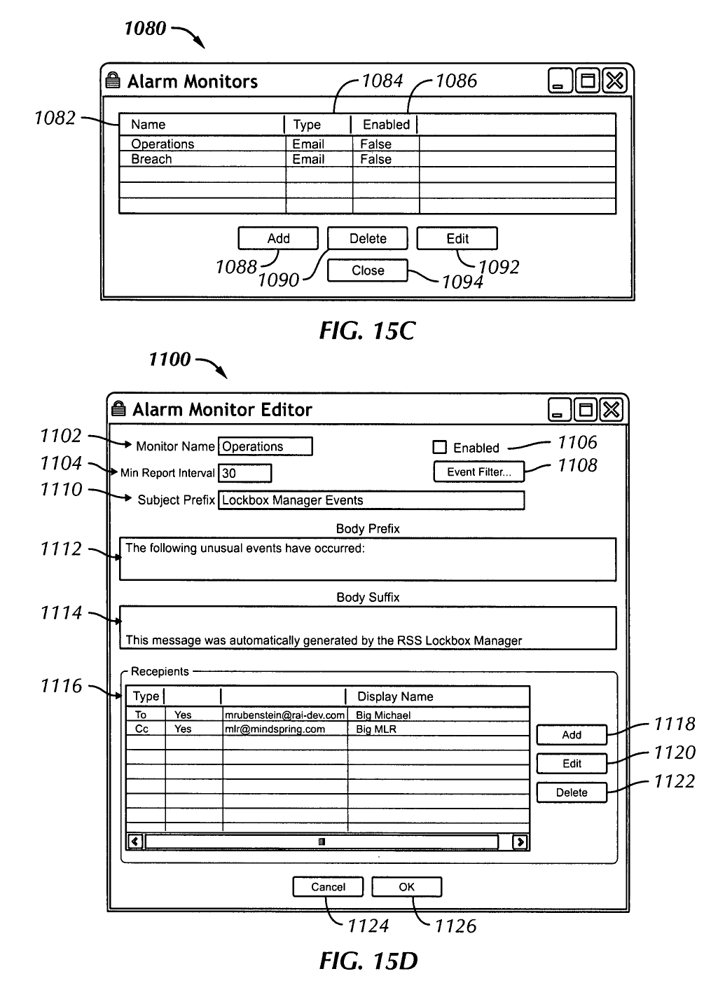

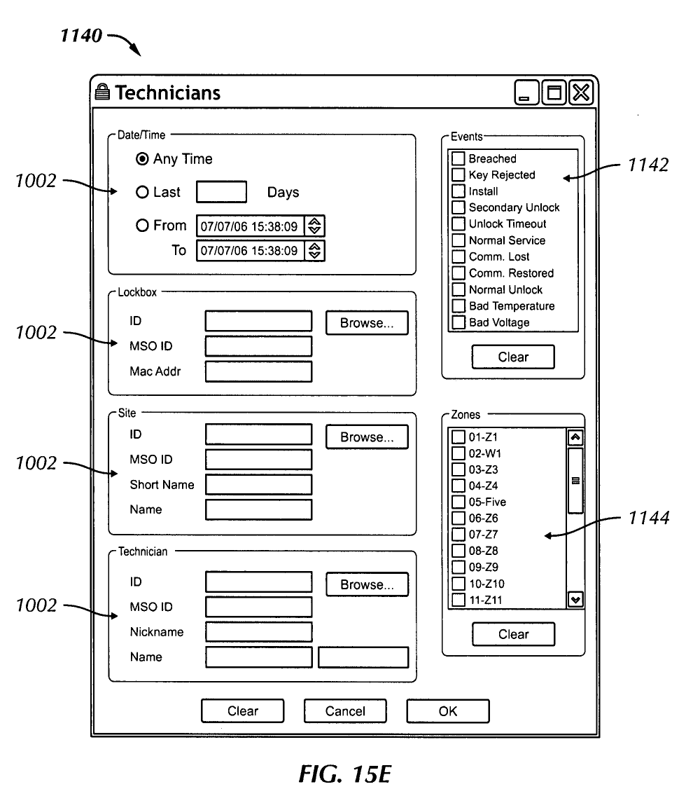

Additionally, in the example user interface, the user may create, modify, and delete alarms from the lockboxes. FIGS. 15A-15E show example user interfaces for the user to modify alarms. Specifically, FIG. 15A shows an example of different alarm menu options that the user may select from the alarms menu (1040) in the manager window (400). As shown in the alarm menu options, the user may generate alarms for the simple mail transfer protocol (SMTP) Server Configuration, receive email alarm monitor, and receive popup alarm monitor notifications.

FIG. 15D shows an example SMTP email server window (1050). As shown in the example, the user may change the email server name (1052), the time for waiting for a server connection (1054), the TCP port to use (1056), whether to use secure socket layer (1058). The user may also create a from address (1060) for the sent alarm notification email, a name (1062) to display on the email, and a user name (1064) and password (1066) for the email account to send the email. Additionally, the user may adjust the frequency to submit email at a minimum (1068), including to indicate that the system is functioning properly, and the frequency to determine whether an email should be sent (1070). Once the user has changed the settings, the user may select cancel (1072) to discard the edits or okay to save the edits (1074).

FIG. 15C shows an example alarms monitor window (1080) for viewing a list of events that may cause alarms. Multiple alarm monitors may be created using the access administration system. For example, each alarm monitor may be for an event or a series of events. The example window of FIG. 15C may be used to show the alarm monitors. The name column (1082) identifies the type of alarm, the type column (1084) identifies how the alarm is sent to a user, and the enabled column (1086) specifies whether the alarm is enabled such that the alarm is created when the event occurs. Further, from the alarms monitory window (1080), the user may select a button to add a new alarm (1088), delete an existing alarm (1090), edit an existing alarm (1092), or close the alarm monitor window (1094).

FIG. 15D shows an example alarm monitor editor window (1100) which may be used to edit an alarm for an email based alarm. Those skilled in the art will appreciate that the email alarm is only one type of alarm that may be sent and that the invention is not limited to email alarms. Alternatively, the alarm may be sent via short message service, or using any other type of electronic communication. As shown in the example alarm monitor window, the user may change the alarm monitor name (1102), the minimum reporting interval (1104) to report the status of the event, and whether the alarm is enabled (1106). Further, the user may the filter events that trigger an alarm. When an alarm is sent, the alarm may be sent via email. In one embodiment of the invention, the user may change the subject line of the email (1110), create an opening statement (1112) and a closing statement (1114) in the body of the email, and identify the recipient of the email (1116). In the example, the user may select a button to add (1118), edit (1120), and delete (1122) recipients from the list. When the user has completed with the alarm monitor editor window (1100), the user may select cancel (1124) to discard changes or okay (1126) to save changes to the alarm.

While not shown in FIG. 15D, a similar window may be used to configure pop-up alerts. The pop-up alerts may be configured according to the type of events causing the alert, the number of reminders of the alert, whether the alert triggers a noise, etc.

FIG. 15E shows an example event filter window (1140) that the user may use to filter events that trigger an alarm. As shown in the example event filter window (1140), the user may filter events based on the type of event (1142), the zone in which the event occurred (1144), the date and time of the event (1146), the lockbox in which the event occurred (1148), the site of the event (1150), and the service technician who caused the event (1152).

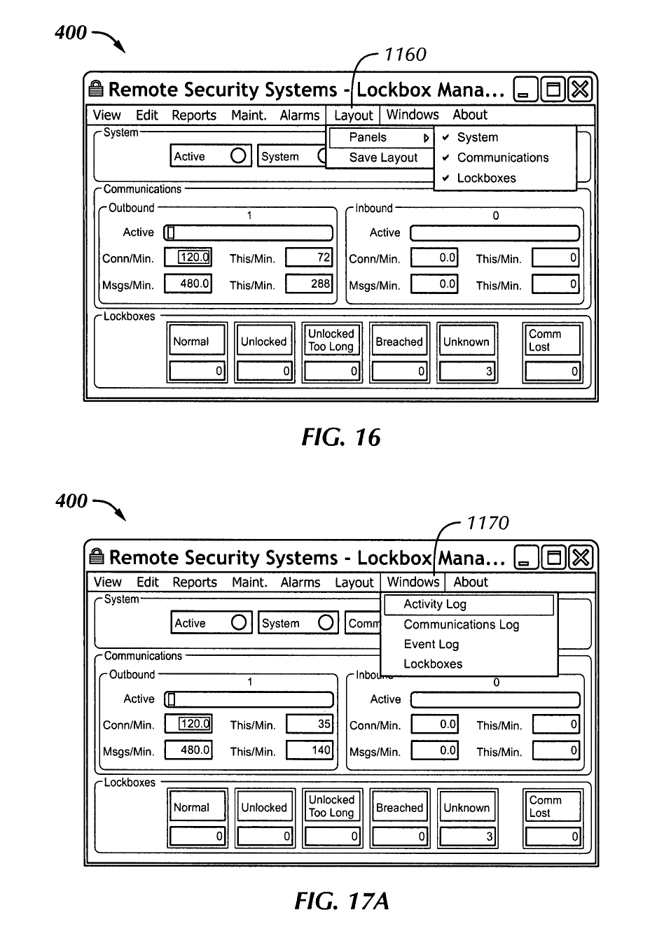

Continuing with the manager window (400), FIG. 16 shows an example manager window (400) which shows a layout menu (1160). As shown with the example layout menu (1160), the user may simultaneously view multiple different panes (i.e., system, communications, lockboxes) in the same window by selecting each pane the user prefers to view. The user may also save the current layout for the next access to the access administration system by the user. Further, the current layout may be saved for each window.

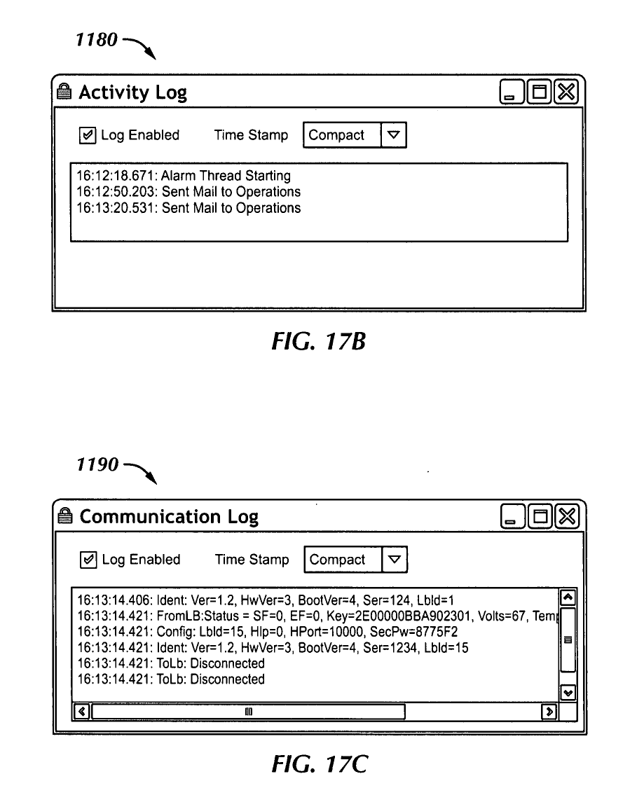

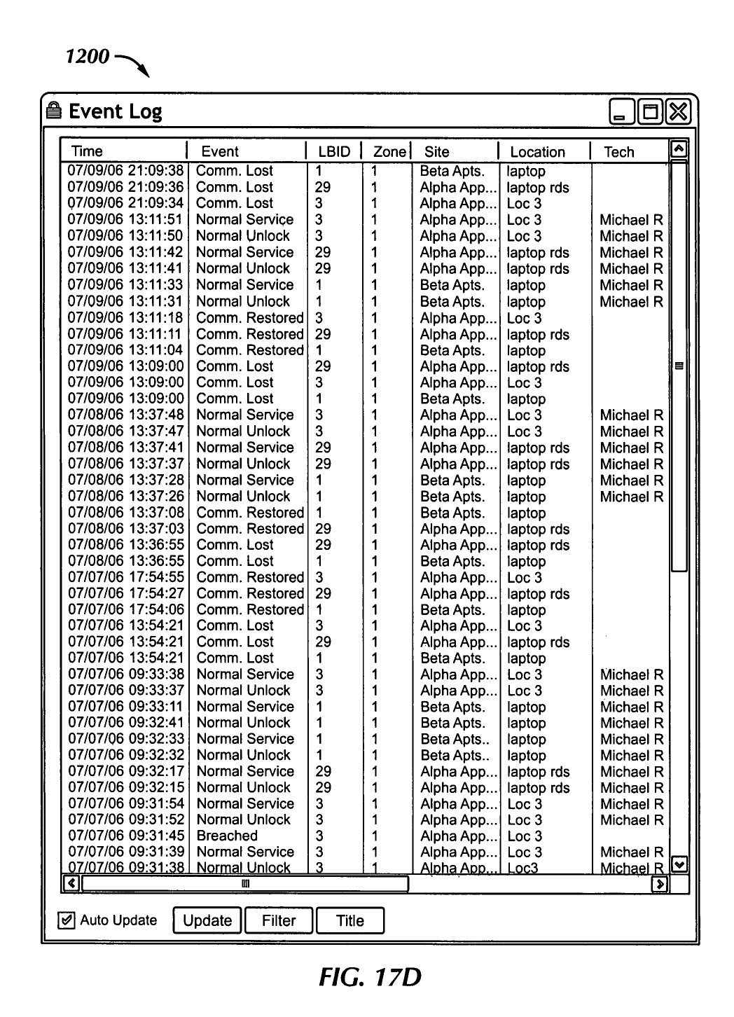

In addition to modifying the layout, the user may also use the windows menu from the manager window to view different logs. In addition, the windows menu may be used to show the different windows that are opened for navigational purposes. FIG. 17A shows the example manager window (400) when the windows menu is selected (1170). As shown in the example, the user may view an activity log, a communication log, an event log, and the lockboxes. FIG. 17B shows an example activity log window (1180) for the user to view an activity log. In the example, the activity log shows a description of the actions performed by the access administration system. FIG. 17C shows an example communications log window (1190). In the example, the communications log window shows a running log of the message exchanges that occur between the access administration system and the lockboxes. The log may be updated in real-time. FIG. 17D shows an event log window (1200). In the example, the event log window may maintain a log of events that occur to the lockboxes. The events displayed in the event log window (1200) may be filtered according to the preferences of the user.

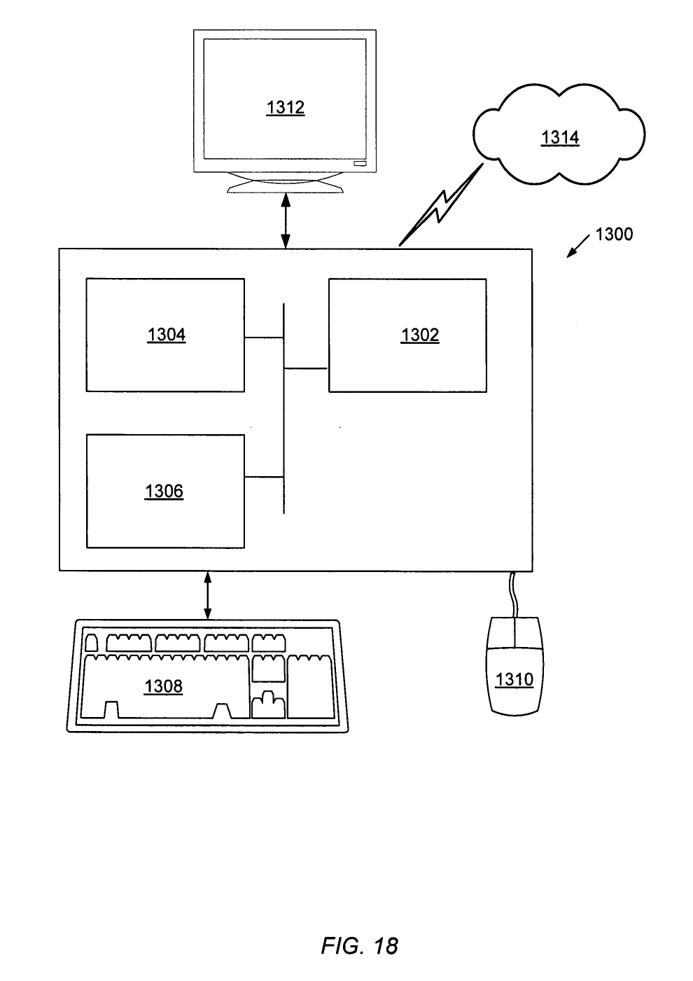

The invention may be implemented on virtually any type of computer regardless of the platform being used. For example, as shown in FIG. 18, a computer system (1300) includes a processor (1302), associated memory (1304), a storage device (1306), and numerous other elements and functionalities typical of today's computers (1314). The computer (1300) may also include input means, such as a keyboard (1308) and a mouse (1310), and output means, such as a monitor (1312). The computer system (1300) is connected to a local area network (LAN) or a wide area network (e.g., the Internet) (not shown) via a network interface connection (not shown). Those skilled in the art will appreciate that these input and output means may take other forms.

Further, those skilled in the art will appreciate that one or more elements of the aforementioned computer system (1300) may be located at a remote location and connected to the other elements over a network. Further, the invention may be implemented on a distributed system having a plurality of nodes, where each portion of the invention may be located on a different node within the distributed system. In one embodiment of the invention, the node corresponds to a computer system. Alternatively, the node may correspond to a processor with associated physical memory. The node may alternatively correspond to a processor with shared memory and/or resources. Further, software instructions to perform embodiments of the invention may be stored on a computer readable medium such as a compact disc (CD), a diskette, a tape, a file, or any other computer readable storage device.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

What is claimed is:

1. A lockbox, comprising:
an access device reader configured to obtain a key code from an access device;
an access control system, operatively connected to an access administration system, configured to grant access to the lockbox when the key code is verified; and
a bidirectional programmable multitap (BPMT) comprising a microprocessor and a tap, wherein the BPMT is controlled by the access control system and wherein the BPMT is configured to send status information about the tap to the access control system.

2. The lockbox of claim 1, further comprising:
an electronic locking device, operatively connected to the access control system, configured to unlock the lockbox when access to the lockbox has been granted.

3. The lockbox of claim 1, further comprising:
a network connection operatively connected to the access control system, configured to provide network services between the access control system and the access administration system.

4. The lockbox of claim 1, further comprising:
a sensor operatively connected to the access control system and configured to monitor the lockbox.

5. The lockbox of claim 4, wherein the sensor is at least one selected from a group consisting of a temperature sensor, a power sensor, a vibration sensor, a visible light receiver, and a motion sensor.

6. The lockbox of claim 1, wherein the access control system is configured to send status information about the tap to the access administration system.

7. The lockbox of claim 1, wherein the access device is an electronic key device.

8. The lockbox of claim 7, wherein the access administration system includes functionality to disable the access device.

9. The lockbox of claim 1, wherein the tap is individually programmed by the access control system via the microprocessor.

10. The lockbox of claim 1, wherein the access control system is configured to obtain data comprising at least one selected from a group consisting of work log data associated with the lockbox and status information associated with the lockbox.

11. The lockbox of claim 10, wherein the access administration system includes functionality to analyze the data to determine whether a response is required and functionality to send an alert to an appropriate entity if the response is required.

12. The lockbox of claim 11, wherein the alert corresponds to at least one selected from a group consisting of an email and a pop-up alert.

13. The lockbox of claim 1, wherein the tap is associated with a filter, wherein the filter is associated with a particular cable service tier.

14. The lockbox of claim 13, wherein the filter is at least one selected from a group consisting of a variable digital filter, a variable analog filter, and a physical filter.

15. The lockbox of claim 1, wherein the lock is opened using a secondary device when main power to the lockbox is off, wherein the secondary device comprises a second access device reader.

16. The lockbox of claim 15, wherein the secondary device opens the lockbox when a master key code is verified by the access control system.

17. The lockbox of claim 16, wherein the secondary device supplies power to the lockbox to perform the verification.

18. The lockbox of claim 16, wherein the verification is only initiated after a device comprising the key code is read by the second access device reader.

19. The lockbox of claim 18, wherein the key code stored in the device is recorded by the lockbox after the master key code is verified.

20. The lockbox of claim 18, wherein the key code stored in the device is recorded by the lockbox prior to opening the lockbox after the master key code is verified.

21. The lockbox of claim 1, wherein the access device reader further obtains an address of the access administration system from an access device.

22. The lockbox of claim 1, wherein the lockbox is a cable distribution box.

23. A system, comprising:
a lockbox, wherein the lockbox comprises:
an access device reader configured to obtain a key code from an access device;
an access control system configured to grant access to the lockbox when the key code is verified; and
a bidirectional programmable multitap (BPMT) comprising a microprocessor and a tap, wherein the BPMT is controlled by the access control system and wherein the BPMT is configured to send status information about the tap to the access control system; and
the access administration system, operatively connected to the access control system, configured to verify the key code.

24. The system of claim 23, wherein the lockbox, further comprises:
a communication device operatively connected to the access control system, configured to provide communication services between the access control system and the access administration system.

25. The system of claim 24, wherein the access device is an electronic key device.

26. The system of claim 25, wherein the access administration system includes functionality to disable the access device.

27. The system of claim 23, wherein the access control system is configured to obtain data comprising at least one selected from a group consisting of work log data associated with the lockbox and status information associated with the lockbox.

28. The system of claim 27, wherein the access administration system includes functionality to analyze the data to determine whether a response is required and functionality to send an alert to an appropriate entity if the response is required.

29. The system of claim 28, wherein the alert corresponds to at least one selected from a group consisting of an email and a pop-up alert.

30. The system of claim 23, wherein the lock may be opened using a secondary device when main power to the lockbox is off, wherein the secondary device comprises a second access device reader.

31. The system of claim 30, wherein the secondary device only opens the lockbox when a master key code is verified by the access control system.

32. The system of claim 31, wherein the secondary device supplies power to the lockbox to perform the verification.

33. The system of claim 32, wherein the verification is only initiated after a device comprising the key code is read by the second access device reader.

34. The system of claim 33, wherein the key code stored in the device is recorded by the lockbox after the master key code is verified.

35. The system of claim 33, wherein the key code stored in the device is recorded by the lockbox prior to opening the lockbox after the master key code is verified.

36. A computer readable medium comprising computer readable program code embodied therein for causing access control system to:
obtain status information from a bidirectional programmable multitap (BPMT), wherein the BPMT comprises a tap and wherein the status information comprises a status of the tap; and
send the status information to an access administration system operatively connected to the access control system.

37. The computer readable medium of claim 36, further comprising instructions to:
obtain a service technician key code from an access device;
send an access request to the access administration system, wherein the access request comprises the service technician key code; and
receive a response to the request from the access administration system;
enable the service technician to access the lockbox when the response indicates that the service technician key code is valid.

38. The computer readable medium of claim 36, further comprising instructions to:
obtain a master key code from a secondary device;
validate the master key code by the access control system, wherein validating the master key code comprises comparing the master key code with a stored master key code; and
enable access to the lockbox when the validation is successful.

39. The computer readable medium of claim 38, further comprising instructions to:
when the validation is successful:
obtain the service technician key code from an access device, wherein the service technician key code uniquely identifies a service technician; and
store the service technician key code in the access control system to obtain a work log.
